(19) United States
(12) Patent Application Publication
(10) Pub. No.: US 2024/0320735 A1
(43) Pub. Date: Sep. 26, 2024

(54) COMPUTING SYSTEM HAVING BLOCKCHAIN BASED TRANSACTION SYSTEM

(71) Applicant: KEO RAILS LLC, Miami, FL (US)

(72) Inventors: Paolo FIDANZA, Miami, FL (US); Farid SHIDFAR, Miami, FL (US)

(21) Appl. No.: 18/608,989

(22) Filed: Mar. 19, 2024

Related U.S. Application Data
(60) Provisional application No. 63/491,967, filed on Mar. 24, 2023.

(51) Int. Cl. G06Q 40/03; G06Q 20/32; G06Q 20/36; G06Q 20/38; H04L 9/00

(52) U.S. Cl. CPC G06Q 40/03; G06Q 20/3274; G06Q 20/3678; G06Q 20/389; H04L 9/50; G06Q 2220/00

(57) ABSTRACT

A computing system for facilitating transactions includes a plurality of computing nodes participating in a distributed ledger on a blockchain that stores transaction blocks and smart contracts. One of the smart contracts is a lending pool smart contract. Each computing node is configured to store and maintain a respective copy of the distributed ledger. A transaction processor is connected to computing nodes and participates in the distributed ledger and transacts between a buyer self-custodial wallet on a buyer computing device and a supplier self-custodial wallet on a supplier computing device. The supplier self-custodial wallet generates and uploads invoices to the transaction processor, which mints the invoices as non-fungible tokens on the blockchain. The buyer self-custodial wallet pays the invoices to buy items via a loan provided by the lending pool smart contract.

### PRIORITY APPLICATION

This application is based upon U.S. provisional Application No. 63/491,967 filed Mar. 24, 2023, the disclosure which is hereby incorporated by reference in its entirety.

### FIELD OF THE INVENTION

The present invention relates to the field of computing systems, and more particularly, this invention relates to computing systems that incorporate blockchain based transaction systems and smart contracts.

### BACKGROUND OF THE INVENTION

Traditional computing systems that operate with credit cards and similar transaction cards are challenged by a fixed billing cycle and settlement date and reliance on third parties for transactions to occur between buyers and sellers. These systems are resource intensive and prone to technical errors, such as latency, failure and outages of one or more servers. They are opaque systems with an inefficient fee structure and are vulnerable to fraud.

Some decentralized computing systems have become more commonplace to facilitate transactions using different smart contracts and crypto currency that may include stablecoin and blockchain storage having a continuously growing list of records as transaction blocks, which are linked and secured using cryptography. New transactions may be added as a transaction block to the blockchain having separate computing nodes, where a block for a new transaction may include a cryptographic hash of the previous block, a time stamp and transaction data. The cryptographic cash generates a fixed-length mathematical representation of a variable amount of data. The decentralized computing system may include multiple computing nodes to receive new financial transactions, generate new transaction blocks, validate the new transaction blocks, and insert new transaction blocks into the blockchain. Small and medium-sized enterprise (SME) inventory systems that takes advantage of blockchain platforms include Buy Now, Pay Later industries. The advantages of replacing normal credit cards for inventory financing would be advantageous when accomplished quickly and without time-consuming middlemen, excess fees, unnecessary cross-border regulations, excess money transfer fees, and similar aspects.

### SUMMARY OF THE INVENTION

A computing system for facilitating transactions may comprise a plurality of computing nodes participating in a distributed ledger on a blockchain that stores transaction blocks and smart contracts. One of said smart contracts may comprise a lending pool smart contract. Each computing node may be configured to store and maintain a respective copy of the distributed ledger. A transaction processor may be connected to at least one of the computing nodes and configured to participate in the distributed ledger and transact between a buyer self-custodial wallet on a buyer computing device and a supplier self-custodial wallet on a supplier computing device. The supplier self-custodial wallet may be configured to generate and upload invoices to the transaction processor. The transaction processor may be configured to mint the invoices as non-fungible tokens on the blockchain. The buyer self-custodial wallet may be configured to pay the invoices to buy items via a loan provided by the lending pool smart contract.

In an example, a lending pool smart contract may hold stablecoin tokens. The buyer computing device may comprise a processor, memory and transceiver. The supplier computing device may comprise a processor, memory and transceiver. The transaction processor may comprise a cloud computing network. The lending pool smart contract may hold stablecoin tokens from lenders used to pay suppliers.

In another example, local on/off currency ramps may be configured to operate with the buyer and supplier self-custodial wallets. The transaction processor may be configured to integrate with the local on/off currency ramps for fiat and stablecoin conversion. The transaction processor may be configured to issue a QR code to a buyer computing device for display thereon. The QR code may contain data of a transaction card for in-person purchases at a supplier. A cache storage may store one or more of access and refresh tokens invalidation, link codes and mobile wallet signed transactions. The lending pool smart contract may comprise a stateful smart contract having loop feedback. The transaction processor may be configured to save the transaction between a buyer and supplier to the blockchain.

### BRIEF DESCRIPTION OF THE DRAWINGS

Other objects, features and advantages of the present invention will become apparent from the Detailed Description of the invention which follows, when considered in light of the accompanying drawings in which:

FIG. 1 is a block diagram showing basic components of the computing system for facilitating transactions using a blockchain in accordance with an example of the invention.

FIG. 2 is another diagram showing basic functional components of the computing system of FIG. 1.

FIG. 3 is a schematic diagram showing the flow sequence of how continuous integration and continuous delivery (CI/DC) are isolated from each other.

FIG. 4 is an entity relation diagram for the computing system of FIGS. 1 and 2.

FIG. 5 is a diagram showing a model of the decentralized computing systems that facilitate transactions showing self-custodial wallets, stateful smart contracts, fungible tokens and other components.

FIG. 6 is another diagram showing a model for the lending pool, tokens and invoice tokenization as an invoice non-fungible token (NFT) and mobile wallets.

FIG. 7 is a flow diagram showing a loan creation process.

FIG. 8 is a flow diagram showing a loan start and lending process.

FIG. 9 is a flow diagram showing a loan payback as a repayment process.

FIG. 10 is a flow diagram showing a pay invoice process.

FIG. 11 is a flow diagram showing a loan payback process.

FIG. 12 is a flow diagram showing a buyer on-boarding process.

FIG. 13 is a flow diagram showing a supplier on-boarding process.

FIGS. 14 and 15 taken together is a flow diagram for the sign-up process for a wallet.

FIG. 16 is a chart for a login flow process.

FIG. 17 is a chart for the screens flowchart.

FIGS. 18-29 are example wire frame screenshots from a mobile device showing operation with the computing system of FIGS. 1 and 2 for facilitating a transaction.

FIG. 30-34 are wire frame screen shots showing an administrator function for different loans.

### DETAILED DESCRIPTION

Different embodiments will now be described more fully hereinafter with reference to the accompanying drawings, in which preferred embodiments are shown. Many different forms can be set forth and described embodiments should not be construed as limited to the embodiments set forth herein. Rather, these embodiments are provided so that this disclosure will be thorough and complete, and will fully convey the scope to those skilled in the art.

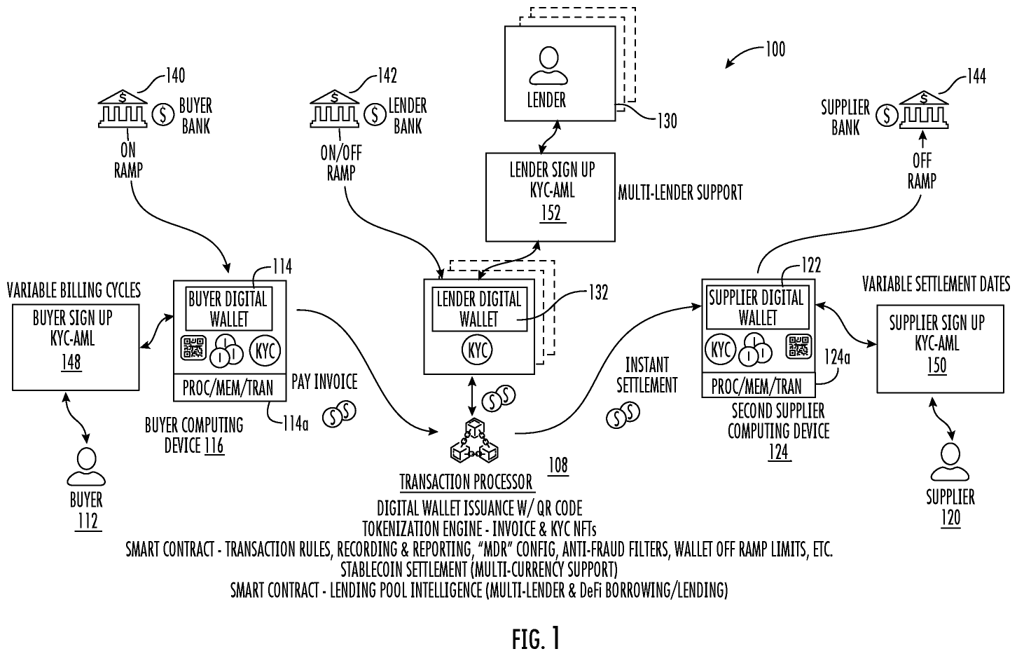

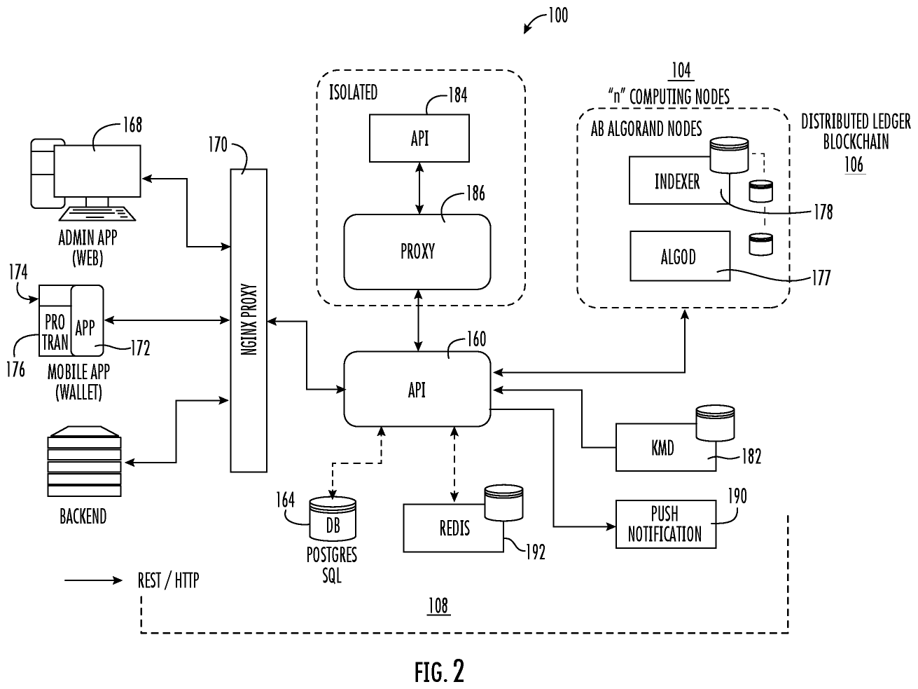

Referring now to FIGS. 1 and 2, there are illustrated a computing system generally at 100 for facilitating transactions. A plurality of computing nodes 104 may participate in a distributed ledger on a blockchain 106 that stores transaction blocks and smart contracts. One of the smart contracts may include a lending pool smart contract. Each computing node 104 may be configured to store and maintain a respective copy of the distributed ledger with further details explained below. A transaction processor 108 may be connected to or part of at least one of the computing nodes 104 and configured to participate in the distributed ledger and transact between a buyer 112 and self-custodial or digital wallet 114 on a first buyer computing device 116 and a supplier 120 self-custodial wallet 122 on a supplier computing device 124. A supplier 120 having a supplier self-custodial wallet 122 may be configured to generate and upload invoices to the transaction processor 108. This transaction processor 108 may be configured to mint the invoices as non-fungible tokens on the blockchain. The buyer self-custodial wallet 114 is configured to pay the invoices to buy items via a loan provided by the lending pool smart contract. Further details of these components and functions will be explained below. The transaction processor 108 may be a network of processing nodes or processors and operates as a platform or network infrastructure, i.e., Rails processor to all digital money transfers. It may be operated by a company, such as Keo, thus, Keo Rails processor network or solution.

In an example, the lending pool smart contract may hold stablecoin tokens. Both the buyer computing device 116 and the supplier computing device 124 may each include a processor, memory and transceiver shown collectively at 116a and 124a. In examples, the transceiver in both devices could be wireless transceivers or transceivers connected to an internet and in some cases even the public switched telephone network. The transaction processor 108 may be a single computer or a network of computing nodes or several computers interconnected together. The transaction processor 108 as a network of processing nodes may also be incorporated as part of a cloud computing network.

In an example, a lending pool smart contract holds stablecoin tokens from lenders used to pay suppliers. Local on/off currency ramps may be configured to operate with the buyer 112 and supplier 120 self-custodial wallets 114, 122. The transaction processor 108 may be configured to integrate with the local on/off currency ramps for fiat and stablecoin conversion. The transaction processor 108 may also be configured to issue a QR code to a buyer computing device 116 for display thereon. This QR code may contain data of a transaction card for in-purchases at a supplier 120. It is possible that the transaction processor 108 could query the buyer 112 to use either a card or self-custodial wallet through the system and the supplier could make that decision for a certain buyer to use a transaction card, for example, American Express. Thus, the system 100 optionally may facilitate transactions and use the blockchain and smart contracts or a standard card such as American Express.

A cache storage as part of the transaction processor 108 and associated databases may store one or more of access and refresh tokens and validation, link codes and mobile wallet signed transactions. The lending pool smart contract may also include a stateful smart contract having loop feedback. The transaction processor 108 may be configured to save the transaction between a buyer 12 and supplier 120 to the blockchain 106.

The transaction processor 108 may be referred to as the Keo Rails (KR) processor or Rails processor, and the system 100 as the Keo system may be part of a larger computer system supported by the blockchain. Partners to the system 100 may operate as a “web3” application for a lending process via a payment rails solution as a payment platform. The transaction processor 108 may be a network and include one or more computers or processors, and may be cloud based with programming to allow buyers 112 to purchase items from suppliers 120 by minting invoices as non-fungible tokens (NFT) on a blockchain 106, such as the Algorand blockchain, and pay them through loans provided by a set of smart contracts, including a key contract as the lending pool (LP).

The computer system 100 with its transaction processor 108 may be backed by stablecoin tokens, for example, USDC tokens that are pegged to the U.S. dollar. A liquidity pool may have lending control logic built into a smart contract. A lending pool may hold USDC funds from lenders 130 operating a lender digital wallet 132 that may be used to pay the suppliers 120. Initially, the solution may be built with a single lender support. Both suppliers 120 and buyers 112 interact with the blockchain 106 using the self-custodial branded or digital wallets 114, 122. Stablecoin on-ramp and off-ramp operations may be assured by a third-party solutions integration. A non-limiting example third party as a peer-to-peer operation and function may be Circle, but other peer-to-peer payment systems may be used.

The computer system 100 reduces deployment-related resource usage with its blockchain based system. Addresses may be cryptographically tied to codes of a smart contract and a blockchain transaction may be performed and trigger a payment or other event. Byte codes may be stored for smart contracts.

The computer system 100 overcomes the challenges associated with traditional systems that include a buyer as a consumer and a supplier where there are fixed billing cycle and settlement dates and the supplier provides goods or services that are purchased by the buyer. This complex ecosystem has reliance on numerous third parties and is resource-intensive to launch a market and prone to technical errors created by latency, failure and network outages. It is an opaque system with an inefficient fee structure and vulnerable to fraud. For example, the buyer may pay $100 and obtain $0.20 in rewards, while the supplier may receive $98 and pays a $2 merchant service where the acquiring services earn a markup and 0.10 scheme fee. Network services may charge fees to the issuer and acquirer and retain $0.20, while the issuing services may retain an interchange and a 0.10 scheme fee.

The system 100 includes a blockchain payment solution that is designed to support variable billing cycles and settlement dates such as key+zero for cross-order and domestic payments and supports multi-currency by leveraging regulated local currency stablecoin to avoid crypto currency volatility and foreign exchange fees for domestic payments. It is designed to integrate with local on/off ramps for fiat and stablecoin conversion. It is designed for multi-lender support and decentralized finance borrowing and lending.

In an example, when a card is not selected for a transaction, and a card is not available or subscribed, there is no reliance on third parties such as a card or point-of-sale issuing since they may be replaced by a digital wallet. The system 100 has low-cost transaction fees and no network outages and is transparent and tamperproof. Payment transactions are secure, compliant and have low fees and use blockchain technology with smart contracts, tokenization and stablecoins. The system 100 does not have custodial of any customer accounts wallet. A reserve account may be in the custody of a financial institution processor network and peer-to-peer service such as operated by Circle. Payment approvals may be secured by two-factor authentication with a mobile wallet private key. A database as part of the transaction processor 108 may have backup and recovery mechanisms with transactions logged and auditing mechanisms.

Referring to FIG. 1, there is illustrated a block diagram of the system 100 showing the transaction processor 108 as a Keo Rails processor network, also referred to as the Rails processor or Rails processor network, that issues a digital wallet with a QR code and includes a tokenization engine for token issuance and issuance of invoices and KYC non-fungible tokens (NFTs). The smart contract has transaction rules, recording and reporting capability, merchant discount rate (MDR) configuration, anti-fraud filters, wallet off-ramp limits and associated matters. The stablecoin settlement may have multi-currency support and the smart contract has a Lending Pool (LP) intelligence with multi-lender and decentralized finance borrowing and lending. The various components in the system 100 are shown as the buyer bank 140, lender bank 142, the lender 130, and supplier bank 144 that interoperate with the buyer digital wallet 114, the lender digital wallet 132, and the supplier digital wallet 122. The variable billing cycles 148 with buyer sign-up and KYC-AML and variable settlement dates 150 with supplier sign-up and KYC-AML are shown. The buyer 112 and seller as supplier 120 are illustrated. Multi-lender support 152 may include lender sign-up and KYC-AML.

The buyer 112 may sign up for a self-custodial digital wallet 114 and view invoices by status and approve/reject invoices. The buyer 112 may deposit funds from a bank account to the wallet 114 and repay loans and view the wallet balance and transactions and download reports as will be illustrated relative to simulated screenshots shown and explained in detail below. The buyer 112 may also reschedule payments and pay invoices directly versus having a lender 130 pay and split payments with direct and/or lender credit. The buyer 112 may withdraw funds from the wallet 114 to a bank account and transact in-person via a QR code. Terms may be pre-negotiated and stored on the blockchain 106 as part of a smart contract and may vary per transaction, such as if a regular card is used, a QR code in-person, or different terms for seller and buyer established. Credit may be configured for each transaction.

The supplier 120 may sign up for a self-custodial digital wallet and issue invoices and accept payments. The supplier 120 may view the wallet 122 balance via a mobile application and withdraw funds from the wallet to an account and download reports. The supplier 120 may also refund buyers and transact in-person with buyers via a QR code and reader. A smart contract per transaction may set up terms. The transaction processor 108 may include lending intelligence determining lender 130 and any future transaction terms.

The system 108 may include processing capability distributed among a plurality of computing nodes, such as at the transaction processor 108 and the blockchain. The transaction processor 108 may issue wallets to suppliers 120, buyers 112 and lenders 130 and ban or suspend wallets. It may set up and calculate transaction fees and rewards and set up who pays on-chain referring to the blockchain fees with buyers 112, suppliers 120 and/or lender 130. The transaction processor 108 may also automatically fund respective wallets for on-chain fees and set up wallet withdrawal limits and check wallet balances. The transaction processor 108 may configure credit validation formulas and send notifications to suppliers 120, buyers 112 and lenders 130 and receive system alerts. It may view, block and approve flagged transactions and download reports. The transaction processor 108 may also set up and calculate transaction fees and rewards for issuers and acquirers.

The lender 130 may sign up for a custodial digital wallet 132 and deposit funds from a bank account to a wallet. The lender 130 may be a company that also operates the transaction processor 108. The lender 130 may pay supplier 120 invoices that may be automated via smart contracts based on buyer approved invoices and extended credit. The lender 130 may also configure loan repayment parameters and issue loan repayment references and withdraw funds from a wallet to a bank account. The lender 130 may view transactions and download reports. The lender 130 may also associate variable settlement dates, support self-custodial lender wallets, support multiple lenders, and support decentralized finance borrowing and lending.

The system 100 may have various notification requirements. To issue digital wallets, the transaction processor 108 may require notification of supplier KYC/AML validation such as from an established business link. To tokenize invoices as NFT's, the transaction processor 108 may require invoice creation notification from a business link. To initiate supplier invoice payments, the transaction processor 108 may require payment scheduler notification from the business link. Business link product modifications may include a modification to allow suppliers 120 to opt into a payment technique and allow buyers 112 to select the payment technique, such as established by the transaction processor 108, if and only if suppliers 120 have opted to accept those processing payments. Thus, there may be an opt in from the card usage to the system 100 that is blockchain based.

The lending process may be initiated by the supplier 120 uploading invoices into the transaction processor 108 application, which are then minted as NFTs on-chain, i.e., on the blockchain 106. The buyer, in turn, approves invoices and sends them for payment through a loan within the lending pool.

Buyers 112 are due to pay back the loans to the lender using the system 100 via the transaction processor 108, surcharged by an interest rate if the payback period is overdue, and by a system fee. The paybacks may be processed by the same lending pool which offered the loan. Therefore, payback funds add to the liquidity in the lending pool. As a result, the lender's return on investment (ROI) is carried out when the liquidity increases due to more loans being paid back.

The system 100 with the transaction processor 108 may operate using three cooperating but independent subsystems, i.e., 1) a “Keo Rails” payments subsystem, 2) a Workeo Business-to-Business (B2B) web application, and 3) a Keo Backend subsystem.

The system 100 and transaction processor 108 may operate an application programming interface (API) to operate invoices and loans on-chain. It may include a mobile application to hold buyers 112 and suppliers 120 in self-custodial wallets. The Workeo B2B subsystem such as operated by the transaction processor 108 is a seamless all-digital working capital solution as an example of a web application used for managing invoices off-chain (off the blockchain) and to onboard and connect buyers 112 and suppliers 120.

The backend subsystem may include an API that is responsible for integrating system payments and a Workeo B2B web application.

Different stakeholders may be included. A first stakeholder may be the buyer 112, which signs up for a wallet and approves supplier invoices as loans. The buyer 112 also checks debt and payment dues, lists invoices by status, lists transactions, pays back loans, deposits funds from bank account to crypto, checks wallet balance, reviews KPIs via Backend/Workeo, downloads reports via Backend/Workeo, adds suppliers via Backend/Workeo, and completes the Know Your Client (KYC) and UR process as via the Backend subsystem.

The supplier 120 as a second stakeholder may sign up for a wallet, lists transactions, checks wallet balance, withdraws funds from a crypto wallet to a bank account, adds buyers via the Backend/Workeo, and completes KYC as part of the Backend subsystem.

An operator, such as the transaction processor 108 operation, is a third stakeholder and may be an administrator as part of the system and overhauls supplier invoices, lists loans by status and account, supplier, date (>, ==, <, interval), configures credit validation formulas, and receives system alerts. The operator also checks accounts for financial status and balance, lists supplier wallets, lists buyers wallets, bans or suspends wallets, views reports and dashboards, configures payback parameters, obtains loan detail by CID, sets up fees and rewards, sets up who pays the on-chain fees, and may engage in customer support.

The application as operated by the transaction processor 108 may be a fourth stakeholder that may include the blockchain 106 and its intelligent processing capability that may validate loans based on credit, check backend endpoints to verify fraud, validate wallets based on fraud formulas, and send notifications. The Keo Rails processor network application may include intelligent lending and may execute payments from a wallet to suppliers' wallets, issue payback payment references, calculate and discount fees and rewards, automatically fund accounts in the blockchain system 106 and rates any limit withdrawals such as off ramping attempts and the amount.

There are various requirements that are considered. Any payment transactions should be secure, compliant and with low fees. The system 100 makes use of blockchain technology. The processor network is not the custodian of any customer account wallets. The processor network may include a wallet issued by the transaction processor as a system reserve account that may be in the custody of a financial institution, such as Circle, Paxos, a specific bank, or other similar institution. Loan approvals may be secured by two factor authentication (2FA) or a similar process, e.g., a mobile wallet private key or similar process. A database may have a backup and associated recovery mechanisms. Every transaction may have logging and auditing mechanisms.

There are different integration requirements. The systems as described coordinate together to achieve the end goals of the payments solution operated by the processor network. For example, the backend subsystem may call the Rails processor network API to create buyers' and suppliers' accounts and wallets. The Workeo subsystem may provide a button for buyers to pay via the processor network. The Workeo subsystem may enable the button if the supplier is willing to extend the payments via the processor network to buyers 112. When an approved invoice is due, the Backend subsystem may call the Rails processor network API to initiate payment. The Rails processor network may notify the Backend subsystem of successful/pending/failed invoice payments.

For integration with the Workeo subsystem, the Backend subsystem may build a payment scheduler similar to that of the Workeo subsystem and enable buyers and suppliers to negotiate payment terms. The Rails processor network may provide endpoints to enable the Backend subsystem to produce reports and views on accounts, wallets and active loans. It is possible to support multi stablecoin using a clone of the Workeo subsystem per stablecoin. The Rails processor network may deploy country-specific instances of its business-to-business application, and if not, the Rails processor network may accept multi-stablecoin via one instance of the business-to-business application. The Rails processor network may provide iOS/Android credentials for an application upload and establish a Circle account. The Rails processor network may provide and maintain application deployment infrastructure system components.

Referring now to FIG. 2, there is illustrated a block diagram showing main components of the system 100 and Rails processor network that may be part of the transaction processor 108 and primary functional block components. An application programming interface 160 (API) is centered around a computing node, such as part of the transaction processor 108, that includes NodeJS as a server network and REST API implemented in NestJS/Fastify for server side applications. The API 160 may be the point of contact for frontend interfaces and other external services. The API 160 may be responsible for implementing off-chain logic related to network operations. The API 160 may also be responsible for initiating and coordinating all on-chain (blockchain) transactions. Buyer 112 and supplier 120 transactions may be signed by self-custodial wallets as mobile applications, for example, a Postgres database SQL (Structured Query Language) (DB) 164 instance may be used for data storage. Charges may be shipped to replica nodes asynchronously with durability of transaction specified per transaction.

Additionally, cache storage as part of the DB 164 or other processor 108 components may be used for transient data needed for some use-cases, e.g., access and refresh tokens invalidation, link codes, and transactions to be signed by a mobile wallet. The API 160 design is modular with a loose inter-module and data model coupling. Whenever applicable, and for scalability reasons, modules may be extracted to isolated services in preparation for micro-service architecture.

The system administrator interface shown as the Admin APP 168 for a web application in FIG. 2 is provided for administration. Different operators for administration in the Rails processor network may use this interface to configure the Rails processor network, manage wallets, and view reports and dashboards. A combination of an nginx server that operates as a web server and proxy 170, including reverse proxy, load balancer, mail proxy and HTTP cache, and may be used for static content. The Rails processor network API backend may serve the web application. This interface is built in React Java Script and client side rendered. In an example, it is not mobile-first designed.

A mobile application 172 may operate on a mobile device 174 shown in FIG. 2, which may include a processor, radio frequency transceiver and operating software shown collectively at 176. The mobile device may include a self-custodial wallet that operates as part of a branded mobile application and established from the Rails processor network and is used for blockchain transaction signing and providing an extra security layer. Authentication and authorization may be based on the private key safely stored inside the mobile device's system vault. The mobile application provides additional simple features, such as viewing wallet balance, listing tokens, and initiating withdrawal or payback requests as illustrated and described later with reference to the figures showing the wallet with reference to the mobile device. The application interface may be built in a React Native as a native application developed in Java Script with support for both IOS and Android mobile devices.

The Rails processor network Application Programming Interface (API) 160 connects to blockchain computing nodes 104, such as Algorand blockchain nodes from Applied Blockchain, via a REST API interface. The API may use as an example the Algorand (Algod) software development kit (SDK) as a JavaScript library for communicating with the blockchain nodes. An API token may secure the connection in http headers. A node may be one of the shared nodes and provide both a service for sending transactions via the process that handles the blockchain shown as Algod 177, and a service for querying the network as shown by the indexer 178 that provides a set of REST API calls for searching blockchain transactions, accounts, assets, and blocks. For example, the indexer 178 REST API's may retrieve blockchain data from a PostgreSQL compatible database 164 that is populated.

The Rails processor as the example transaction processor 108, custodial wallet's private keys may be secured inside a KMD server 182 as a node that may operate as an Enterprise Information Management (EIM) platform to improve workflows. This node may use a REST API interface with a two-layer security algorithm as an API key and secret wallet password. The KMD server 182 may be used for Rails processor 108 internal accounts operating the system on-chain, such as the operator account. All critical system operations, including deploying contracts and funding system accounts, may be secured by external cold wallets, and thus, are not stored in the KMD server 182 for security reasons.

Referring to the isolated API 184 and proxy 186 such as operated by Circle, a peer-to-peer payment proxy API, which may be referred to as Proxy API, such as operated by Circle, may be employed with the Rails processor 108, which leverages peer-to-peer services for buyer's on-ramping fiat to stablecoin (USDC) via payments or transfers and for supplier's off-ramping stablecoin (USDC) to fiat via wire transfers. The Rails processor wallet may be a Circle account in a non-limiting example. The peer-to-peer service integration may be accomplished via a peer-to-peer payment service API REST interface secured by a key pair API token/secret key. For security reasons, and to better secure access credentials within the peer-to-peer payment service, the proxy API server 186 may be designed between both APIs 184 and 160. The Proxy API 184 may be deployed to an isolated cluster and connected through a REST API interface.

As illustrated, the API 160 may include push notifications 190. The Rails processor network may send notification messages to mobile applications as wallets to initiate transactions from buyers 112 and suppliers 120. Users may be notified to open their wallets and review and sign the required transactions. The push notification system 190 may be used to deliver messages to connected mobile devices on both IOS and Android systems. The API 160 also may operate with the Postgres SQL database 164 as an SQL relational database with built-in binary replication and transferring data changes to replica nodes asynchronously. It may operate read-only queries against replicated nodes to split read traffic among multiple nodes efficiently. The remote dictionary store (Redis) 192 may operate as an in-memory data structure store and operate as a store and cache at the same time, and may be a NOSQL database, with numerous simultaneous connections. The B2B backend 194 is shown.

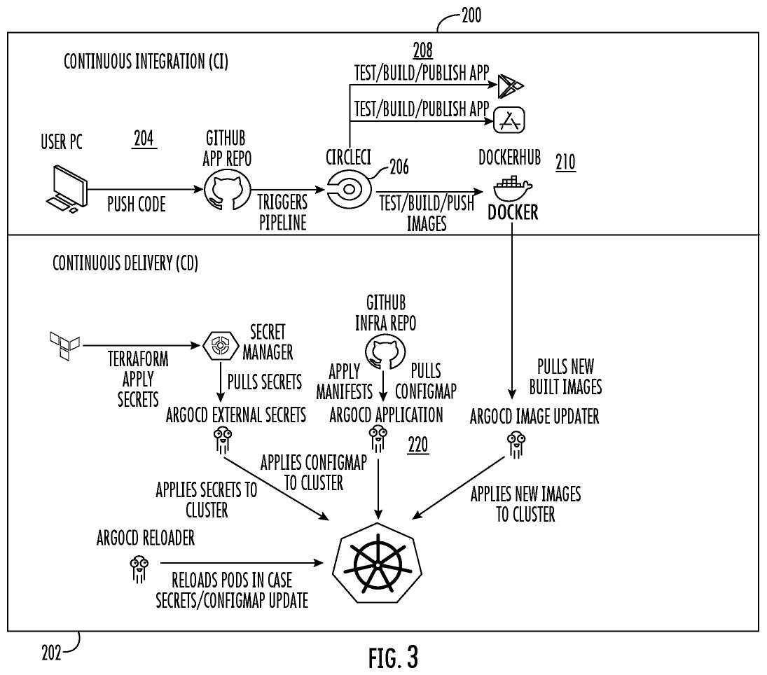

As shown in FIG. 3, a Continuous Integration (CI) module 200 and Continuous Delivery (CD) module 202 are isolated from each other. On one side, the Continuous Integration module may operate with a user PC and Githup App 204 and may use a program component as from Circle CI 206 to manage the pipelines 208 and may be responsible for doing tests during a pipeline run, building docker images and pushing them to a DockerHub 210. The Continuous Integration module 200 may be used to test, build and publish mobile applications for Android and IOS.

The blockchain Continuous Delivery module 202, such as from ArgoCD 220, within its applications and may be responsible for a Continuous Development module. It may apply the application manifests, configmaps, namespaces and other application components. It is possible to use an Image Updater module, such as ArgoCD, to roll out updates when a new docker image is published in DockerHub. An External Secrets module may be used to pull secrets from a Secret Manager module and inject data as a secret into a cluster. An Image Reloader module may watch the secrets and configmaps for changes in order to make a rolling restart to pods.

The Rails processor network as an associated transaction processor 108 includes a security scheme. Users of the Rails processor network API as a public application or administrator application may be authenticated using a JSON Web Token (JWT) as an access token that is included in an authorization http header. Access tokens may be short-lived and last minutes in duration, and thus, users may also be given a JWT refresh token stored in a cookie with the Secure, HttpOnly and Same-Site=Strict attributes. Cross-Origin Resource (CORS) sharing in an example may not be allowed. The refresh token may allow for a new access token to be generated that may expire, but in a much longer time interval such as in hours. A blacklist of invalidated tokens may be maintained in a cache to support user sign-out or reset password flows.

There may be risk assessment because despite preventive measures put in place to mitigate risk, blockchain technology has some risks, such as related to data privacy and user tracking. Data stored on-chain is publicly available by nature. If sensitive information is posted to a public ledger, it may be read by the public. Accounts on the blockchain 106, such as by Algorand, may be anonymous, but it may be possible to trace the transactions made by an account/wallet on-chain. While transparent transactions assure investors, as they see the historical performance of the platform and anonymous accounts, an independent observer may try to guess the anonymous account owners based on the frequency or amounts in various published transactions.

There are solutions to obfuscate wallet ownership by rotating accounts/addresses used by each wallet. This can be complex to implement and operate. The Rail processor 108 may implement wallets and user self-custody wallets may bring power to the user, and additional security requirements to be followed. The Rail processor 108 may not hold any information that enables access to a wallet or restoration of its access. Users may be solely responsible for storing safely and securely wallet passwords and any mnemonics. Unauthorized access to the wallet's mnemonic or private key may result in substantial financial damage, including the loss of all funds and assets in the wallet's possession. The Rails processor 108 may be designed with security considerations for storing and using wallets' private keys inside the mobile application. The private key may be generated inside the wallet, and may never be revealed to the Rails processor 108 API or other external systems.

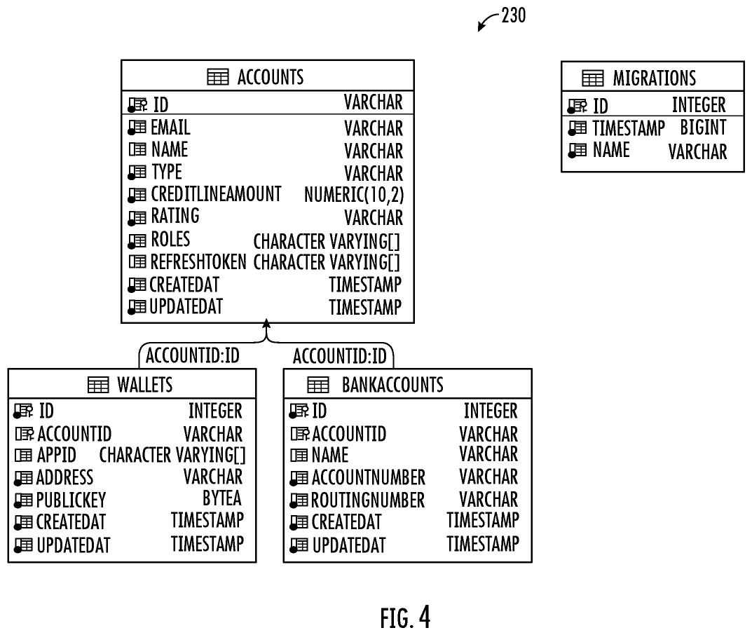

Referring now to FIG. 4, a current state Entity Relation Diagram (ERD) 230 for the Rails processor 108 and associated database is illustrated and shows the relationship among the wallets and bank accounts with their account ID, and the accounts and the migrations, interpreting with the wallets and bank accounts.

The Rails processor 108 includes smart contract design and a decentralized web application (dApp) that runs on the preferred blockchain similar to a peer-to-peer network. It is a complex scheme including self-custodial wallets, stateful smart contracts, fungible tokens and NFTs. There are various on-chain components that interact with each other. Backend code may run on the decentralized peer-to-peer network as the blockchain in this instance. Different categories include lending and borrowing, derivatives, decentralized exchange, assets and payments.

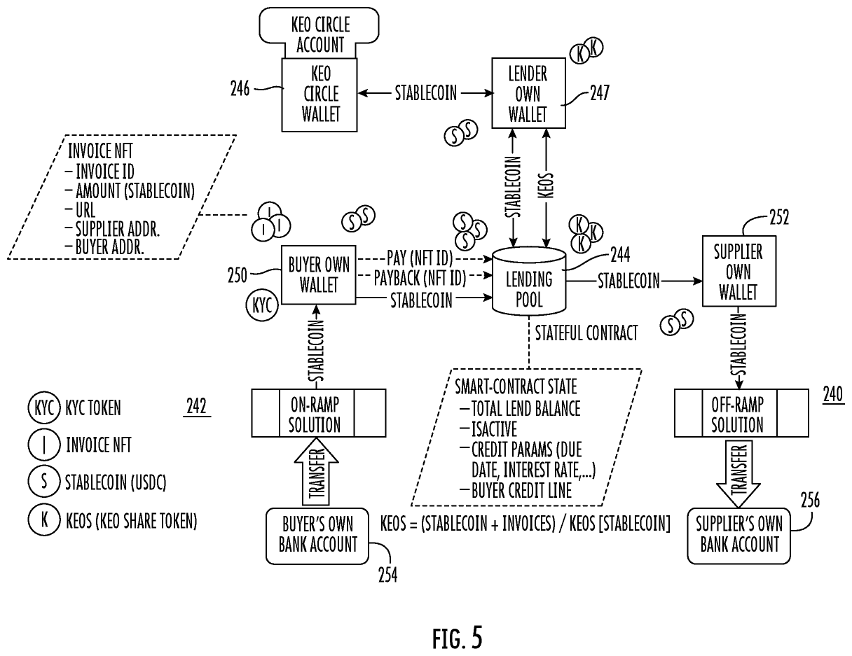

Referring now to FIG. 5, the block diagram illustrates a strategic solution model diagram for the smart contract design used in the system 100 and provided by the Rails processor 108. There is illustrated off-ramp capability 240 that permits the exchange of crypto currencies for fiat and assures that buyers and sellers may “exit” and sell crypto for fiat and are not locked into the crypto. On-ramp 242 provides acquisition. The Lending Pool (LP) 244 is a smart contract incorporating a liquidity pool that may include digital currency locked in a smart contract and loan logic. The Lending Pool 244 as a smart contract and can be used to lend and borrow funds, tokenize debt, and track interest earned or due and as illustrated, operates with the buyer wallet 114, supplier wallet 122, and lender wallet 132, which interoperates with the KEO circle wallet 246 associated with the Keo Circle account.

The Lending Pool 244 may pay supplier invoices, on behalf of the buyer 112, with funds it holds due to the lender's staking in the pool, and by creating a loan. Buyers 112, in turn, pay back loans, i.e., Lending Pool paid invoices, by sending stablecoin to the Lending Pool 244 with interest and a fee surcharge. Funds flow in and out of the Lending Pool 244 in stablecoin, whereas the protocol is grounded by custom tokens such as a KeoS token, KYC token and an Invoice NFT token. The various components and their interoperation are shown in FIG. 5 and include the Keo wallet 246, lender own wallet 247, buyer own wallet 250, and supplier own wallet 252. The on-ramp solution 242 is shown with the buyer wallet 114 and the off-ramp solution 240 is shown with the supplier's own bank account 256 or own wallet 252.

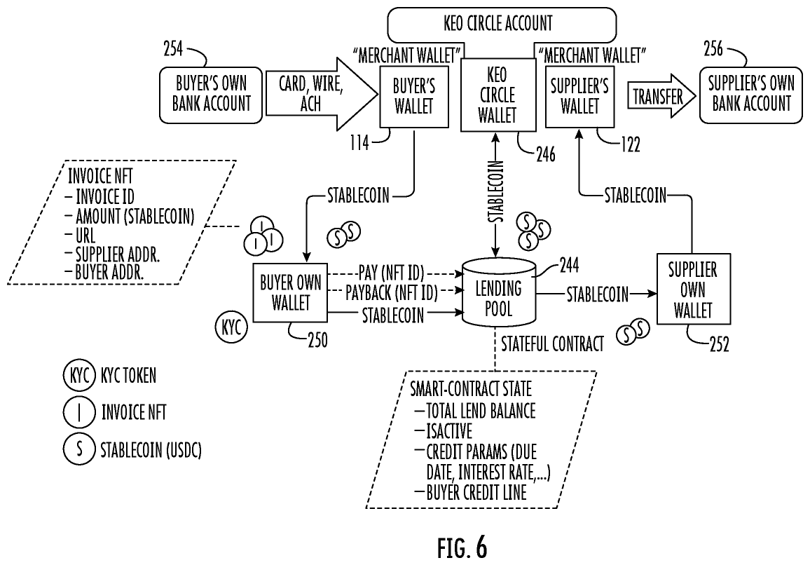

The lending process that may be used with the system 100 and its Rails processor 108 is briefly described in the non-limiting example such as shown in FIG. 6. The lender may stake stablecoin in the Lending Pool 244 in exchange for Keos system tokens, which may include share tokens that is used to make payments for sharing services. Different wallets are illustrated, including the buyer's wallet 114, supplier's wallet 122, buyer and supplier own wallet 250, 252, buyer and supplier own bank account 254, 256, the KEO circle wallet 246, and the transaction processor 108 operated by Keo. The supplier may be on-boarded, and the supplier wallet 122 address is whitelisted as a security feature to allow crypto withdrawals to go to the verified address. The buyer 112 completes the KYC process and receives a credit line in the buyer's local state of the Lending Pool 244. A KYC token is granted to the buyer's wallet 114 as proof of the KYC'ed status. An invoice submitted by the supplier 120 is verified by Rails processor 108 and approved by the buyer 112. An approved invoice is minted as an NFT token in the buyer's wallet 114. The buyer calls the Lending Pool 244 smart contract to “pay” the invoice, spending a certain amount of his credit line balance. The Lending Pool 244 checks the NFT token authenticity and ownership, the buyer's KYC status, and supplier's wallet 122 address whitelist status. The Lending Pool 244 transfers stablecoin to the supplier's wallet 122 address to settle the payment.

For the loan payback, the payback process is briefly described. The buyer 112 calls the Lending Pool 244 smart contract to “payback” the loan, transferring enough stablecoin to the Lending Pool 244 to pay the loan amount plus interest and fees. The Lending Pool 244 computes the loan amount due and compares it with the buyer's transferred amount in stablecoin. An amount equivalent to the loan amount is added to buyer's credit line balance. At this point, the invoice NFT is burned. The lender 130 withdraws funds by sending “Keos” tokens as the implementer of the system 100 and operating the transaction processor 108 to the Lending Pool 244 in exchange for stablecoin. The exchange rate is calculated according to the lender's Keos share and the actual stablecoin liquidity in the Lending Pool 244.

On/Off-ramp operations to convert fiat currency to stablecoin may be provided by third-party solutions for peer-to-peer payments such as Circle, Paxos, Killb or others. Buyers 112 and lenders 130 may use the on-ramp services to buy stablecoin tokens, depositing them in their self-custodial wallets. In turn, suppliers 120 and lenders 130 may use the off-ramp services to sell stablecoin tokens from their self-custodial wallets, receiving fiat currency as the government-issued currency not backed by a physical commodity in their bank accounts. The Rails processor 108 includes a solution to rate limit the number of withdrawal (off-ramp) attempts and amounts to protect against fraudulent and money laundering activities.

It is possible to have multiple stablecoin support. The system 100 with its Rails processor 108 as described uses a single stablecoin token. Should support for other stablecoin tokens be required, e.g., to avoid the foreign exchange (FX) on different demographics, a clone of the system may be necessary per stablecoin token that is supported. This results in dedicated Lending Pools, fungible tokens and on/off ramp solutions.

The system 100 and its Rails processor 108 may be implemented in two stages. In a first stage, the Lending Pool 244 and mobile wallets may be implemented. An example of the Lending Pool 244 and mobile wallets and their interoperation is shown in FIG. 6.

The foundation for the Lending Pool 244, KYC tokens, invoice tokenization as an Invoice NFT, and mobile wallets has been established. At this stage as an administrator for the system 100 and Rails processor 108 may be the single lender and funds are transferred from the Circle wallet to the Lending Pool 244 without exchanging Keo's tokens as share tokens. Buyers and suppliers have their self-custodial wallets and on-ramp and off-ramp stablecoin via Keo's Circle subaccounts as merchant wallets.

The self-custody wallet is different from a digital wallet such as Paypal and is a place where digital money such as digital currency and other digital assets are stored and also known as a non-custodial wallets that transact with blockchain-based financial applications such as a liquidity pool and other decentralized finance applications. The self-custody wallet stores “private keys” that permit the user to securely access their blockchain-based assets, such as the conduct crypto currency and digital coins. Each private key corresponds to a public key, also known as the wallet address and the pair of public and private keys are used to gather to transact on the blockchain 106. The pair as the public and private keys are unique and many self-custody wallets generate them using special algorithms.

The public key acts as an identifier for the account on the blockchain 106 similar to an email address and funds may be received by telling the wallet address as a public key. The private key is used to sign and improve the transfer of digital money similar to a password, but only the wallet owner has access to the private key. They are securely stored. The private key corresponds to the public key to confirm that funds belong to the owner. An accessing service like borrowing, investing and trading. The term self-custody signifies that the possession of the digital money or other digital assets are in the user because they control the private key and safeguard access. The self-custody wallet can be linked to a bank to deposit digital money to the liquidity pool 244. The self-custody wallet may include a mobile wallet such as on the mobile device and the private key generated and stored on the device with backup and recovery options. The smart contract wallet may be deployed on the blockchain 106 and may have a mobile application for desktop interface. The smart contract wallets may be programmed in different ways.

The liquidity pool 244 may be a system of smart contracts on the blockchain 106 where a user may earn interest by supplying assets to a shared liquidity pool from anywhere in the world and it is possible to borrow the digital assets from the liquidity pool by posting collateral or other techniques. Borrowings may be paid back with interest with everyone following transparent rules of a smart contract. Digital assets may be supplied to the liquidity pool to earn interest. The system 100 has funds as liquidity for the liquidity pool 244 at all times with the pooled liquidity and multiple parties forming a greater liquidity pool. Interest rates may be computed algorithmically depending on supply and demand of digital assets.

The smart contract operates as a digital contract that is programmed to execute when the predefined conditions are met and once met, transactions are added to the blocks in the blockchain for processing. The smart contract running the blockchains 106 require the digital assets and digital currency to pay for transaction processing. Smart contracts may be programmed to oversee and handle entire transactions, replacing lawyers since software engineers have written the contract to govern the digital asset transaction. The decentralized applications as the Dapps are built around the smart contracts and deployed to a blockchain 106. The self-custody wallets allow users to access the decentralized applications. The transactions are immutable and once the smart contract executes a transaction, it may not be reversed where records of the transaction are distributed across the decentralized blockchain network making it impossible for anyone to remove the records. They are self-executing on its own since it determines that conditions are met.

The stablecoin is a fiat-backed digital currency such as USDC with value pegged to the US dollar. It may follow the token standards and is currently issued and redeemed, such as via Circle and coin base, for example, as members of the Centre Consortium. For example, the consortium may hold US dollars and equivalents and reserves backing USDC coins in circulation and supervisor rules and regulations.

The decentralized finance replaces the traditional finance and intermediaries by the blockchain 106 and smart contracts. The fiat-backed stablecoins are collateralized 1:1, allowing every stablecoin in circulation to have a single unit of currency such as one dollar kept in a bank account to back it up. It is possible for the user to trade in the stablecoin for cash and receive the equivalent directly from Circle for the USDC stablecoin or purchase it on a crypto exchange such as Coinbase. Blockchain 106 applications may run on the blockchain. The blockchain 106 decentralized applications for lending and borrowing may include liquidity protocols.

It is possible to use hardware wallets and a physical device similar to a USB. It is possible to have a non-custodial wallet that has multiple keys where a smart contract in use may be secured using three keys where two out of three keys may be required to make a transaction. If one key is stolen, then the thief will not be able to access the funds. A key can be stored in the cloud and another key stored in the mobile device and another key stored in an administrator secure server infrastructure to allow seamless recovery of the non-custodial wallet using a cloud drive, email and phone number. The blockchain address used by a user may operate similar to an email that can be used to transfer money.

In an example, stablecoin tokens deposited into a buyer's wallet are automatically transferred to the buyer's wallet 114. Similarly, stablecoin sent to a supplier's Circle wallet may trigger a wire transfer to the supplier's bank account. On/Off ramp operations may be implemented via Keo's Circle account by calling Circle APIs. In the second phase, the system 100 and associated Rails processor 108 are with the Keo share token and lender's wallet, therefore adding full support for a multi-lender Liquidity Pool.

Each transaction on the blockchain 106 incurs a small transaction fee which may be paid by the sender of the transaction. By default, unless the account has enough blockchain currency, such as Algos as a non-limiting example, each blockchain action on behalf of a user is preceded by a “funding transaction,” in which an Keo-owned faucet account gives out small crypto awards and sends the required amount of blockchain currency to the account. The crypto faucet account rewards holders with instant payments in the form of crypto currencies in exchange for completing tasks on the website.

There is an interplay of accounts as the wallets, the stateless and stateful contracts, and the state that is stored on-chain for implementation in the blockchain 106. Those details include the creation of the loan, its start such as lending, loan payback as repayment, and an initial setup as a one-time process, buyer on-boarding, supplier on-boarding, and lender withdrawal.

The stateful smart contracts are more flexible than stateless smart contracts that have better scale and security. They are based somewhat on the modern digital circuit with state lists or a combination of digital logic with the if/then, and/or inverter/etc. blocks with no internal state, but it can combine with larger systems that have internal states. The stateful or sequential digital logic has internal states in addition to the if/then/and etc. blocks and has loops that may feed back into the circuit. Smart contracts are a block in the decentralized stack and process business logic in a decentralized fashion and sit side-by-side with file storage and databases. The stateless smart contract has no internal state, while the stateful or sequential smart contract has the internal state and loops and recursion.

Most business contracts do not have loops or recursion and can be handled by the more scalable and easier to verify stateless smart contracts. The stateless smart contract may process arbitrary logic that does not retain state internally and may have the Boolean inputs, Boolean operators and Boolean outputs. For example, a Boolean input may be signature, time or facts with the scripting in some digital currency supporting combination of business logic. An inter-ledger protocol may have different cryptographic conditions to specify combinational circuits. A stateful or sequential business logic does not retain state internally and has memory or may be a combinational logic circuit with at least one feedback loop and perhaps a clock in various memory such as flip-flops to store state. Sequential logic may be used instead of combinational logic if loops or recursion is desired. In business contracts, it is not as common. It may include client-side processing where the mobile application browser does the computation.

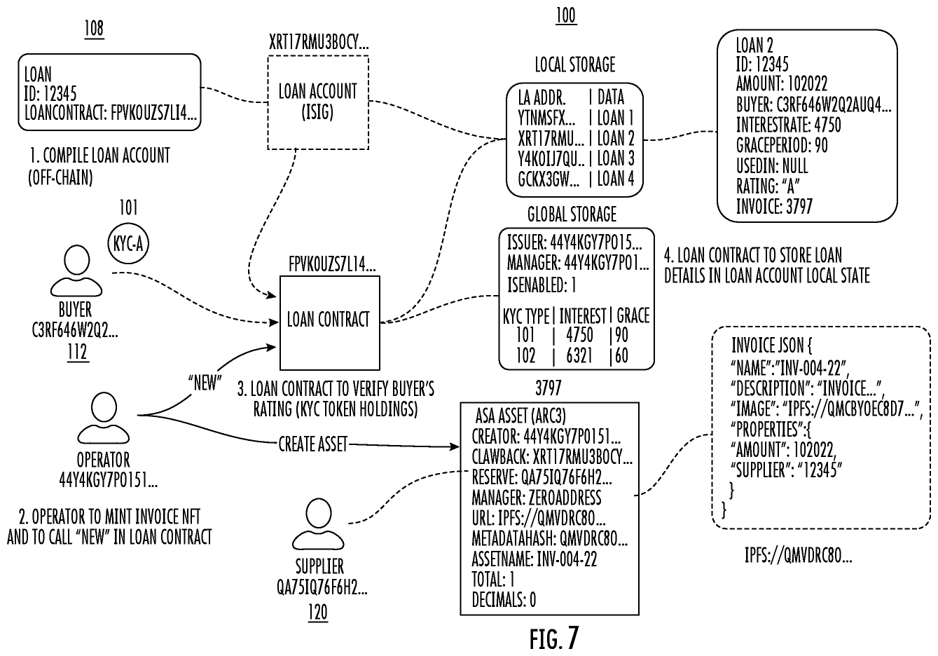

An example of the process for creating a loan is shown in FIG. 7. Simplified, alpha-numeric identifiers are given to the buyer 112, operator as “Keo” that operates the system 100 and transaction processor 108 and supplier 120, and each block in the drawing has details of the particular structural function. As indicated in step 1 shown by the numeral 1, the Rails processor 108 compiles the Loan Account (Lsig contract) including a loan ID and loan contract address. At the second step, the operator mints an invoice NFT and calls the “new” method in the loan contract. At the third step, the loan contract verifies the buyer's credit rating, (i.e., KYC token holdings). At the fourth step, the loan contract stores loan details in the Loan Account local state. The different identifiers and associated items are shown for the different block components such as loan, loan contract, local storage, global storage, ASA (assets) and invoice.

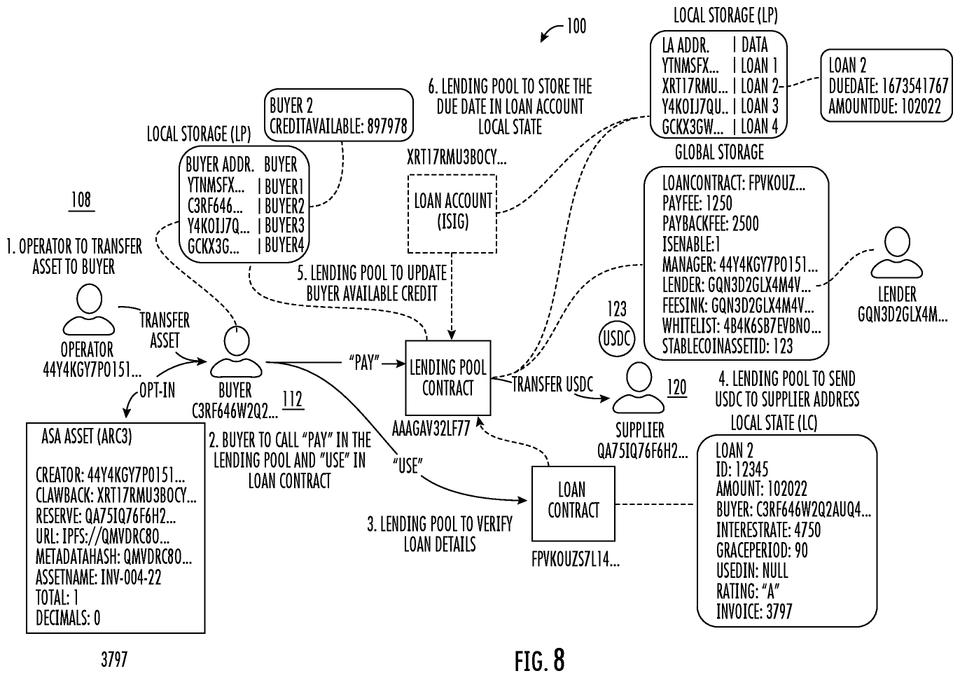

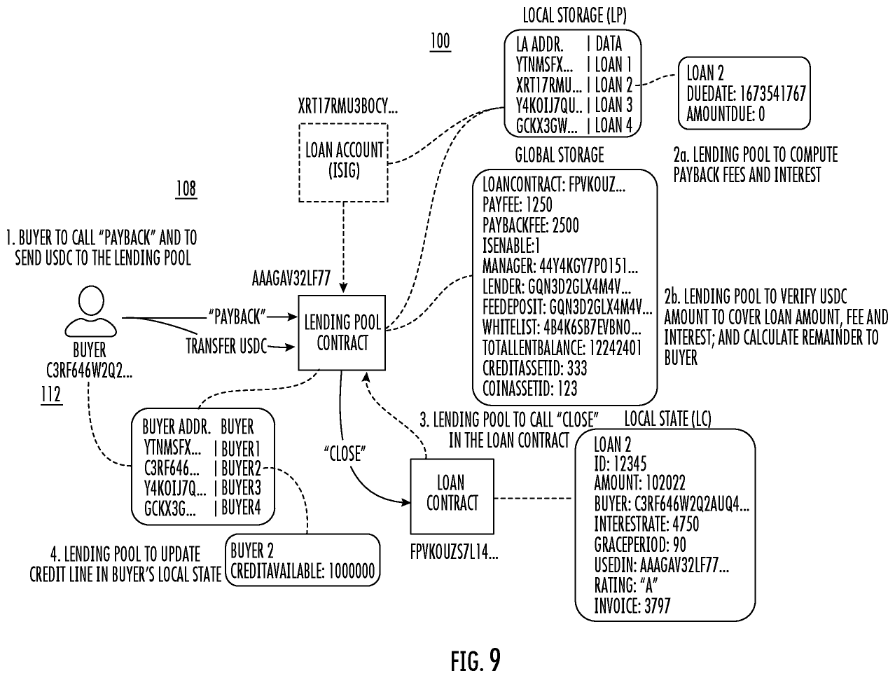

Referring now to FIG. 8, the process for starting the loan, e.g., loan lending, is illustrated similar to the format of FIG. 7. In a first step, the operator transfers the asset as the invoice NFT to the buyer account. In the second step, the buyer will call the “pay” method in the lending pool and the “use” in loan contract. In a third step, the Lending Pool will verify loan details. In the fourth step, the Lending Pool transfers stablecoin to the supplier account. In a fifth step, the Lending Pool updates the buyer's available credit balance. In a final sixth step, the Lending Pool stores the due date in the loan account local state.

Referring now to FIG. 9, there is illustrated a process for loan payback (repayment) shown in a format similar to that of FIGS. 7 and 8. In a first step, the buyer calls “payback” method in the Lending Pool and to send stablecoin (USDC) to the Lending Pool. In a second step, there is on-chain (blockchain) processing inside the Lending Pool. In step 2a, the Lending Pool computes the payback fees and interest, and in step 2b, the Lending Pool verifies the stablecoin amount to cover the loan amount, fee and interest. In a third step, the Lending Pool calls the “close” method in the loan contract as an inner transaction. In a fourth step, the Lending Pool updates the credit line in buyer's local state.

The initial setup may be a one-time process and may begin with an Administrator account such as operated by Rails processor 108 and that is external to deploy the loan contract. An Administrator account may deploy the Lending Pool contract, followed by the external Administrator account deploying the Whitelist contract. The process may continue with the reserve account minting KYC tokens and the Lending Pool account that may opt-in to stablecoin. The Lender account may transfer stablecoin to the Lending Pool account.

The Buyer 112 on-boarding process may include the Buyer account to opt-in to KYC token, followed by the Buyer account to opt-in to the Lending Pool 244 and set a credit line balance. The Buyer account may opt-in to stablecoin (USDC), and may have a reserve transfer KYC token to the Buyer's account that is frozen.

The Supplier 120 on-boarding process may include the Supplier account that may opt-in to the Whitelist contract, and the Supplier account to opt-in to stablecoin (USDC), and the Operator account to add the Supplier account to the Whitelist. The Lender 130 withdrawal process may include the Lender account (external) to call “withdraw” in the Lending Pool contract and the Lending Pool account to transfer stablecoin (USDC) to the Lender account.

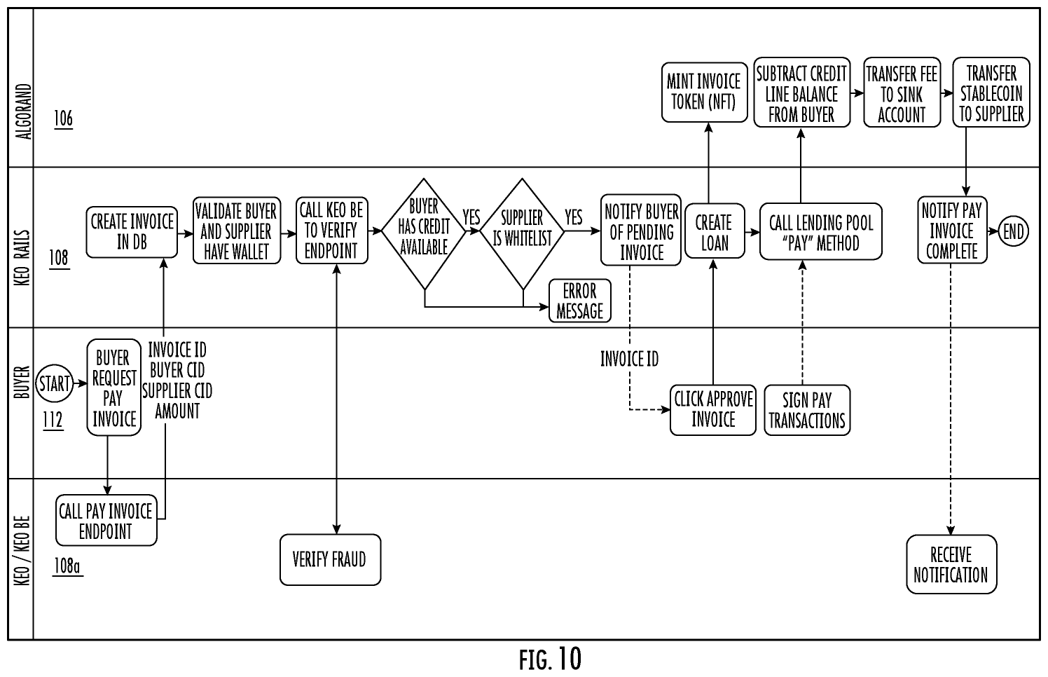

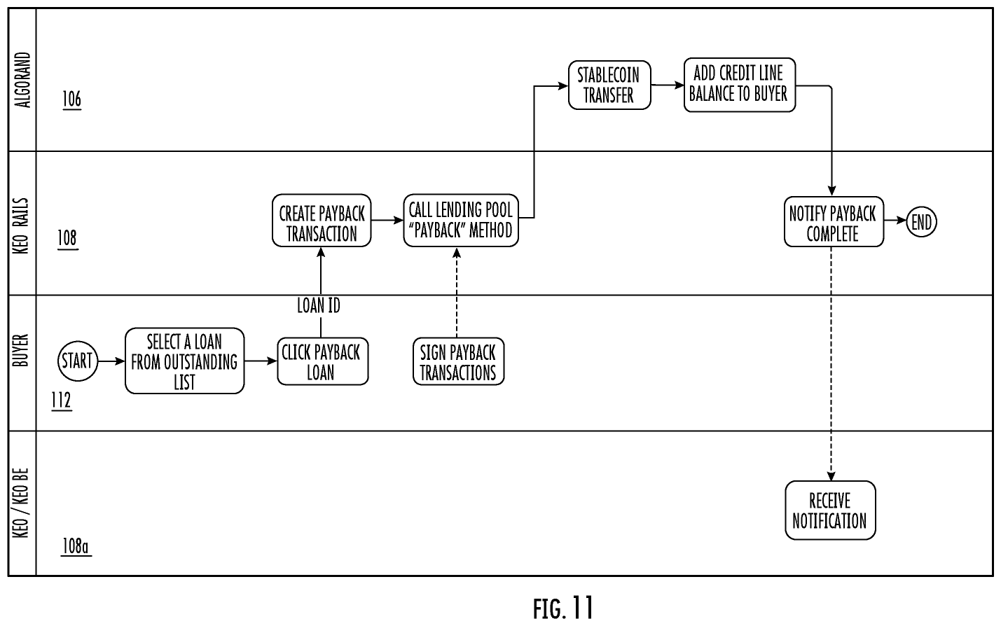

Different use cases for the Rails processor 108 are possible. In a first use case shown in FIG. 10, an example of the pay invoice method and flow is explained. The pay invoice flow is used to pay suppliers and initiate buyer's loans. The blockchain 106, Rails processor 108, buyer 112, and backend 108a. The process starts with the buyer approving an invoice and selecting the Rails processor 108 as the payment method, in an example, an all-digital working capital application. The approved invoice is then scheduled and sent to Rails processor 108 via the backend subsystem 108a when payment is due.

Pay invoice requests that are received by the Rails processor 108, are first stored in a Rails database subsystem and then sent for validation, which checks them against: 1) the buyer's and supplier's eligibility (both should have “ready-to-use” wallets), 2) the buyer's remaining credit amount, 3) fraud, and 4) supplier whitelist status. If any validation fails, invoices may be flagged, and an error message may be thrown. Otherwise, invoices may be marked as ready for payment, and a notification may be sent to the buyer's wallet 114 as part of the mobile application to inform of a pending invoice.

Buyers 112 are required to open the application as a wallet to confirm the payment transaction, such as by an action, clicking “approve invoice,” virtually signing off a loan contract with the Rails processor 108. As a result, the Rails processor 108 creates a loan and mints the invoice as a non-fungible token on-chain.

The Rails processor 108 then prepares all the transactions required to call the Lending Pool 244, sending them on chain, i.e., on the blockchain 106, for payment settlement. Upon successful execution on-chain, the credit line balance is deducted from the buyer's state, stablecoin tokens are transferred to the supplier's wallet, and a fee is transferred to a sink account. The Rails processor 108 notifies the backend subsystem 108a (Keo operated) of successful payments through the Rails processor.

Referring now to FIG. 11, the process for loan payback is illustrated. Buyers 112 use loan payback flow to repay their outstanding loans with the Rails processor 108. Loans may be effectively paid back to the same Lending Pool 244 which originally paid the supplier invoice. Therefore, buyers 112 may be required to send stablecoin to the Lending Pool 244 to cover the invoice amount plus interest and service fee. This flow assumes the buyer 112 already has enough stablecoin in his wallet to initiate the payback. If that is not the case, the buyer 112 must first complete the “on-ramp” process to deposit funds in their wallet.

To initiate the payback process, buyers use their wallets to select a loan from an outstanding list of loans and click to payback. The Rails processor 108 then prepares the transactions required to call the Lending Pool 244, sending them on-chain 106. Upon successful execution on-chain 106, the buyer's credit line balance is restored in the exact amount of the loan being paid back. The Rails processor 108 notifies the backend subsystem 108a of successful paybacks through the Rails processor.

The on-ramp flow for the deposit of funds has certain characteristics. The mobile application may give buyers transfer instructions, including a unique reference number, which buyers use to start a wire transfer from their own bank account to the “Keo” or administrator Circle bank account. In addition, different payment methods can be offered to buyers, such as credit cards or ACH as the Automated Cleaning House for electronic fund transfer (EFT). Once funds are received in Keo's Circle bank account, the Rails processor 108 receives a notification and reconciles the transfer against the reference number and buyer's account address. Immediately, stablecoin tokens are transferred to the buyer's wallet.

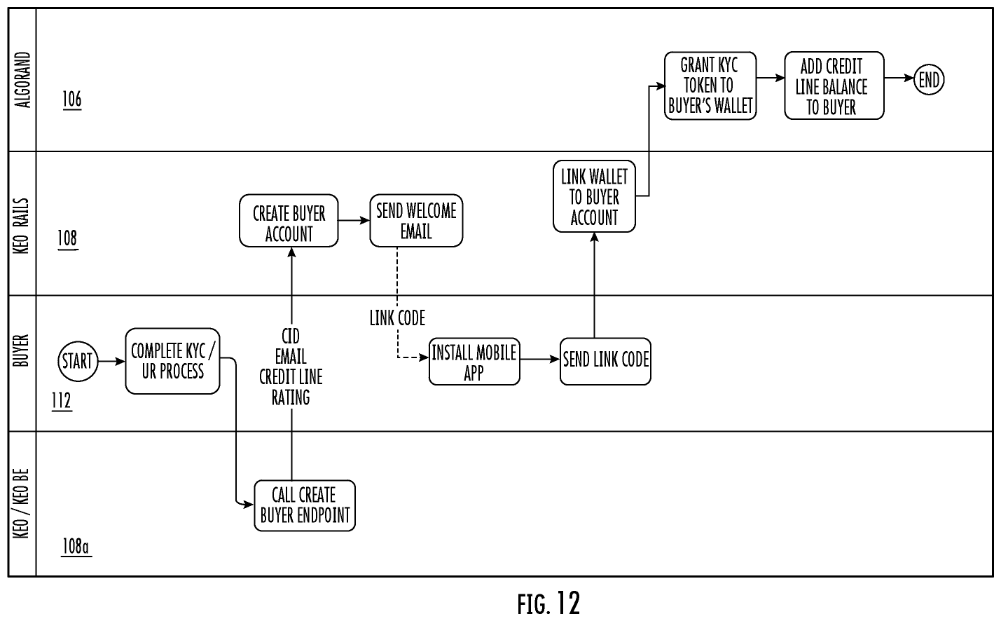

The buyer on-boarding process is shown in FIG. 12 and starts by completing a KYC/UR process that includes the underwriting (UR) with the Rails processor 108 such as via offline. Then, for every KYC′d buyer, the backend subsystem 108a calls a Rails processor API endpoint to create a buyer's account, passing some parameters, such as CID, email address, amount of credit approved and buyer's credit rating that may also refer to the class. Based on the information provided, the Rails processor 108 creates an account in the internal database and sends a welcome email to the buyer prompting the buyer to download the mobile application as the wallet. At the same time, the Rails processor 108 API generates a link code, associates it with the account, and sends it to the buyer.

The buyer 112, in turn, installs the application and uses it to send back to the Rails processor 108 API the link code passed to the buyer by email. The Rails processor 108 API verifies the code and links the buyer's wallet address with the account in the database. Upon successfully linking the buyer's wallet, the Rails processor 108 API triggers the initial wallet process on-chain such as the Algorand blockchain 106, which includes granting a KYC token and adding to the buyer's credit line balance in the Lending Pool local state.

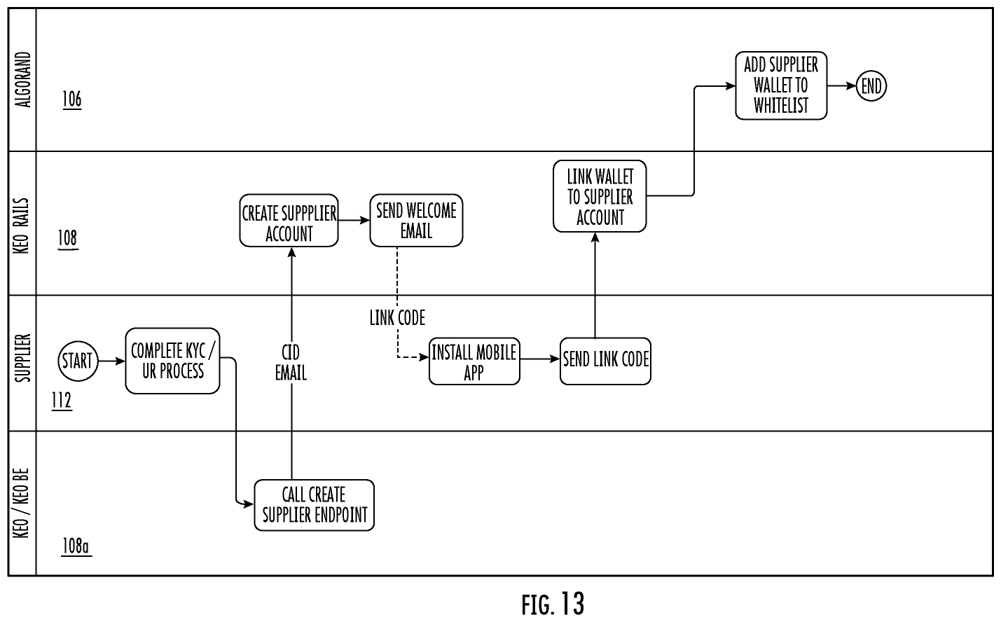

The supplier 120 on-boarding process is shown in FIG. 13 and works similar to the buyer's counterpart without the credit line. It starts by completing the KYC process and possible underwriting (UR) with the Rails processor 108 offline. Then, for every KYC′d supplier, the backend subsystem 108a calls a Rails processor 108 API endpoint to create a supplier's account, passing some parameters, such as CID and email address.

Based on the information provided, the Rails processor 108 API creates an account in the internal database and sends a welcome email to the supplier 120, prompting the Rails processor to download the mobile application as the wallet. At the same time, the Rails processor 108 API generates a link code, associates it with the account, and sends it to the supplier 120.

The supplier, in turn, installs the application and uses it to send back to the Rails processor 108 API the link code passed to the supplier 120 by email. The Rails processor 108 API verifies the code and links the supplier's wallet address with the account in the database. Upon successfully linking the supplier's wallet, the Rails processor 108 API triggers the initial wallet process on-chain (Algorand), which includes adding the supplier's wallet address to the whitelist.

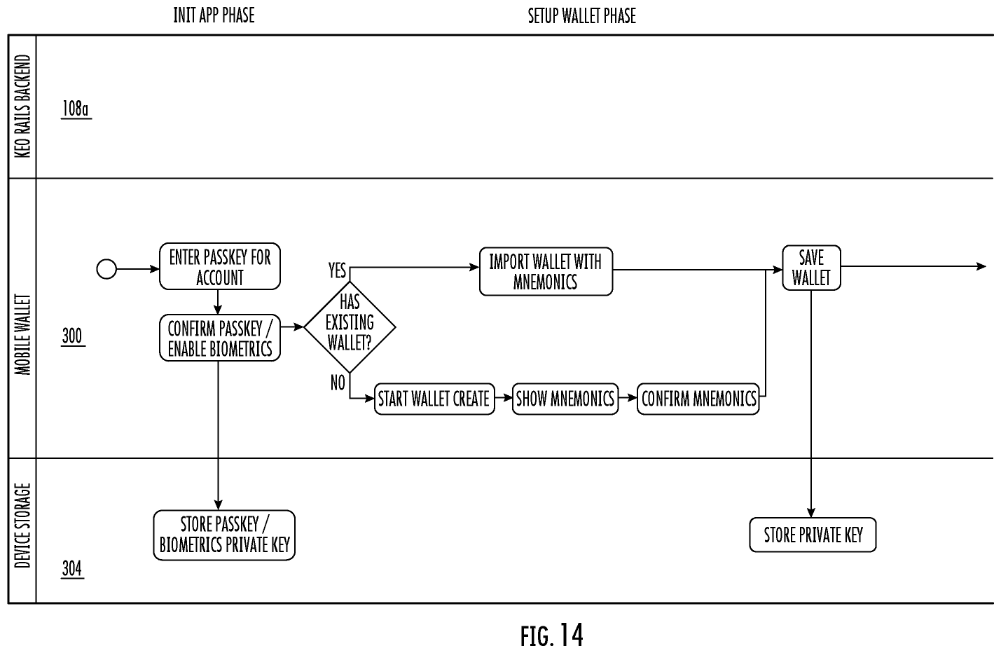

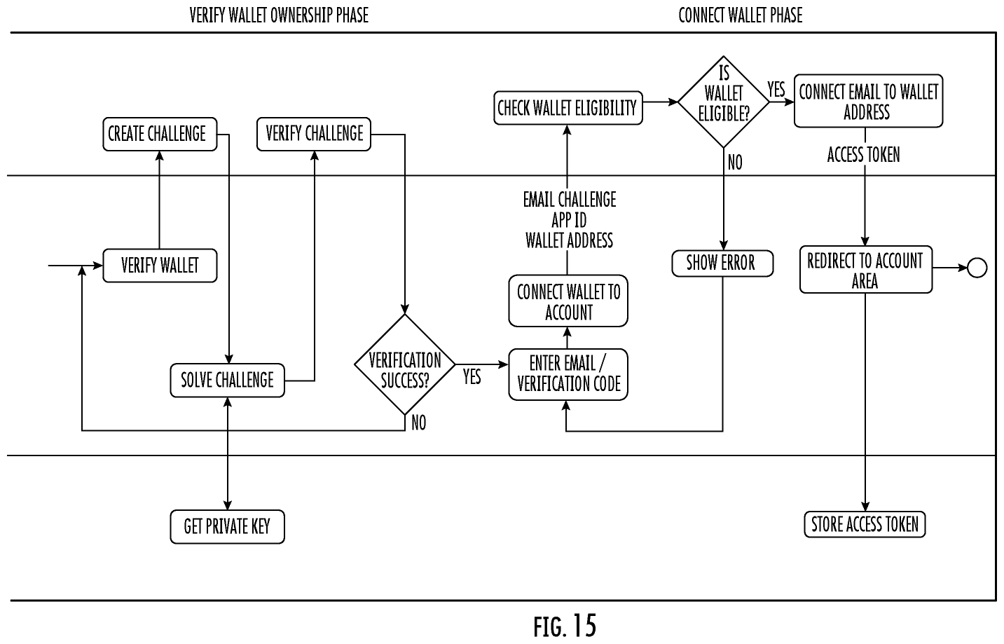

The sign-up flow for the mobile application design is used to authenticate, authorize and link the wallet with the buyer or supplier accounts in a database for the Rails processor 108. It may include in an example four phases, which are shown in FIGS. 14 and 15 when read together as: 1) the Initiate Application phase, 2) the SetUp Wallet phase, 3) the Verify Wallet Ownership Phase, and 4) the Connect Wallet phase. The KEO Rails backend 108a, mobile wallet 300, and device storage 304 are shown on the left.

An initial sign up flow is shown in FIG. 14, and may be read in conjunction with the sign up flow of FIG. 15. The application is downloaded from an on-line stores, such as the Apple Store or Google Play Store, with a clean state, i.e., no data is stored inside. Not even the wallet private key is set by default. The first two phases are directed to setting up this custom data and enabling the security features.

The first initiate application phase is required to set up the application passkey, such as the access PIN, which is used to secure local access to the application. The passkey is required to open the application and is used internally to encrypt the wallet's private key before storing it in the device's storage, typically a mobile device such as an iPhone. Therefore, users will have to input the passkey whenever transactions are to be signed.

In the second setup wallet phase, a user may issue a new wallet or import an existing one. A wallet may be represented by a pair of private/public keys generated from a random seed. The seed can be represented in mnemonic format to ease the import and export processes. In an example, a mnemonic may be a set of 25 random words in English. To create a new wallet, the application generates the seed and presents it in mnemonic format. Users are required to store it safely since it will not be persisted in the application, nor in the Keo Rails processor network database for security reasons. Users are then prompted to confirm the mnemonic by inputting a subset of the words presented.

To import a wallet, the users need to input all words in the correct order of a valid mnemonic. Once the setup phase is complete, the application encrypts the private key and stores it in the application's device storage, together with additional information, for example, the wallet name.

As shown in FIG. 15, the third verify ownership phase is used to authenticate the wallet with the Rails processor 108 API and permits the new wallet to prove the ownership of the private key associated with the public key of the wallet. To prove the ownership, the wallet has to sign a challenge given by the API. The challenge may be a grouping of data that includes a grouping of readable information such as the issue and expiry date, API ID and a nonce such as a random number used in one occasion. The wallet uses the stored private key to sign and then sends the signature back to the API. The Rails processor 108 API can verify the signature by combining the challenge, the wallet's public key, and the signature provided by the wallet. If the signature can be verified, access can be granted. The API as the user interface answers with a guest access token, authorizing the wallet to access some API resources.

The fourth connect wallet phase in FIG. 15 shows how new verified wallets are linked with a buyer or supplier account in the Rails processor 108 database. The connect wallet phase makes this link. As part of registering an account in the Rails processor 108, an email is sent to the email address associated with the account. In this email, a one-time random link code is provided, which is required to be used in this phase. By verifying this code, the Rails processor 108 API can link the wallet and the account. It is clear from this algorithm that only a person with access to the registered email account can link a wallet. The Rails processor 108 API is required to perform wallet eligibility verification as the account might be already linked with another wallet, or the link code might be already expired.

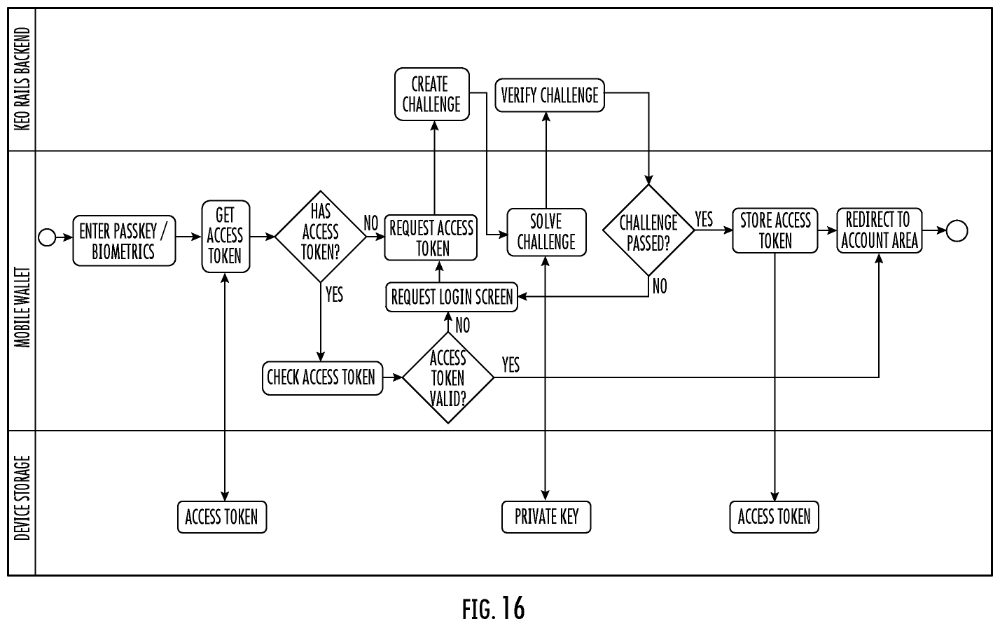

The login flow is shown in FIG. 16. To access the Rails processor 108 API resources, the wallet has to authenticate first. Therefore, the wallet uses the login flow as illustrated to authenticate and obtain a valid access token as an authorization. This process is similar to the “verify ownership phase” process described before in the signup flow. For authentication, the wallet may have to sign a challenge given by the API. The challenge is a grouping of data that includes a group of readable information such as the issue and expiry date, API ID and a nonce such as random number. The wallet uses the stored private key to sign in and then sends the signature back to the API.

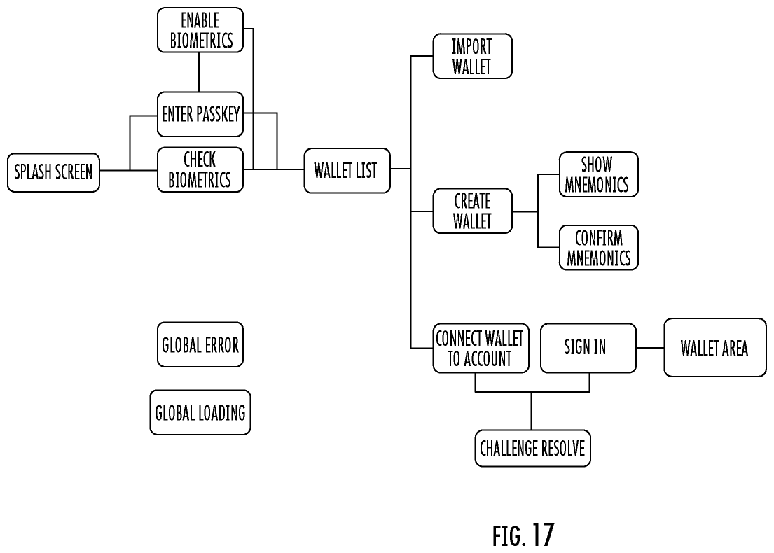

The Rails processor 108 API can verify the signature by combining the challenge, the wallet's public key, and the signature provided by the wallet. If the signature can be verified, access can be granted. The API answers with an access token, authorizing the wallet to access other API resources. The login flow is required whenever the access token expires. Therefore, this flow includes checks to verify the token expiration state, only starting the challenging part if the access token is outdated. Refresh tokens may be introduced to allow very short-living access tokens that are more secure without overloading the challenge process or compromising the UX as a user experience. The mobile application can use the refresh token to obtain a valid access token without requiring the challenges signature. The screens flowchart is shown in FIG. 17 and shows the basic screens that may be shown during the process described above.

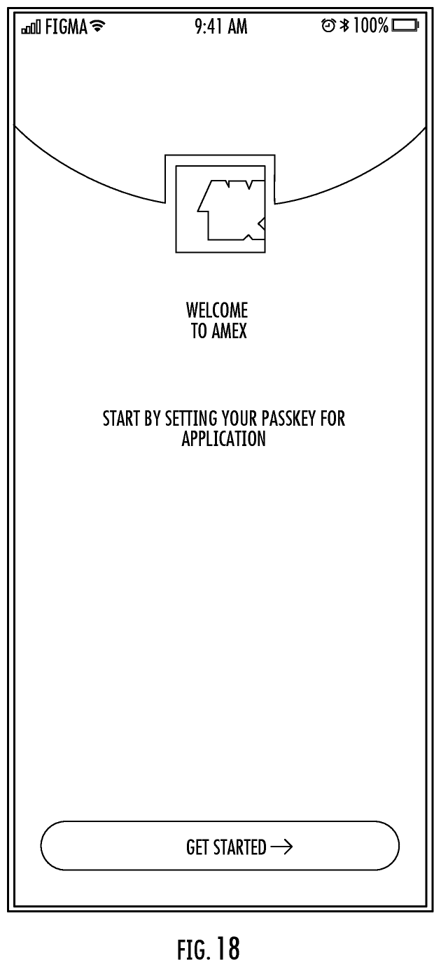

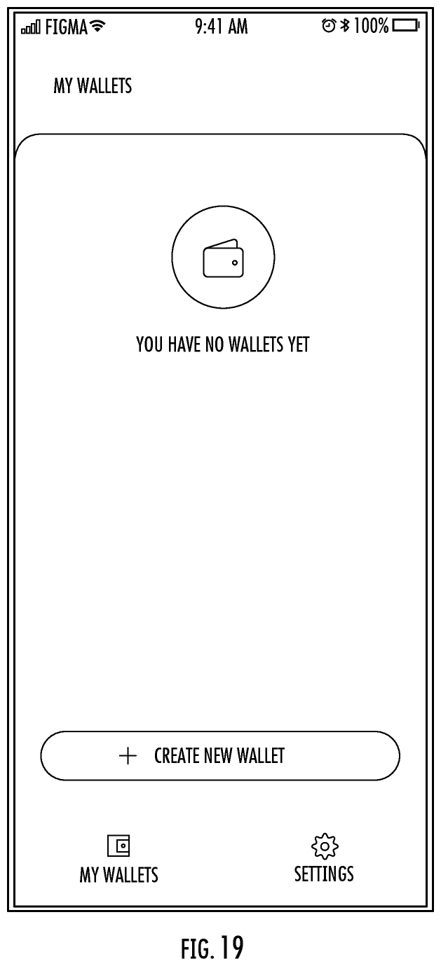

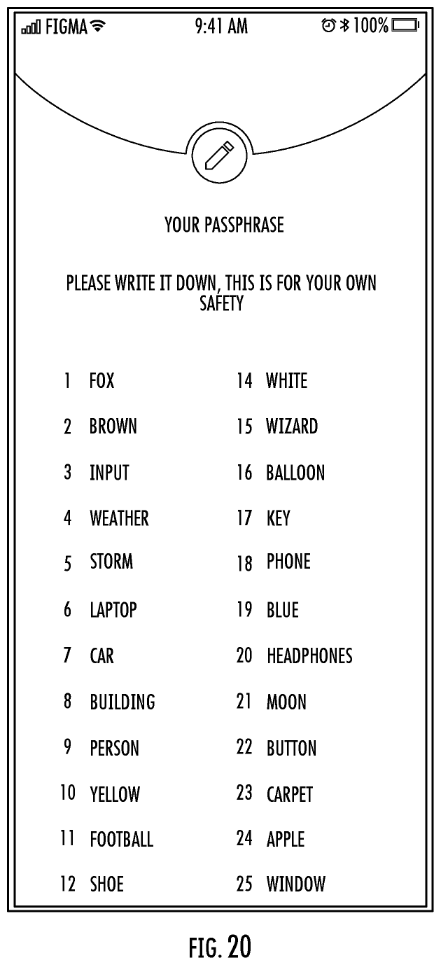

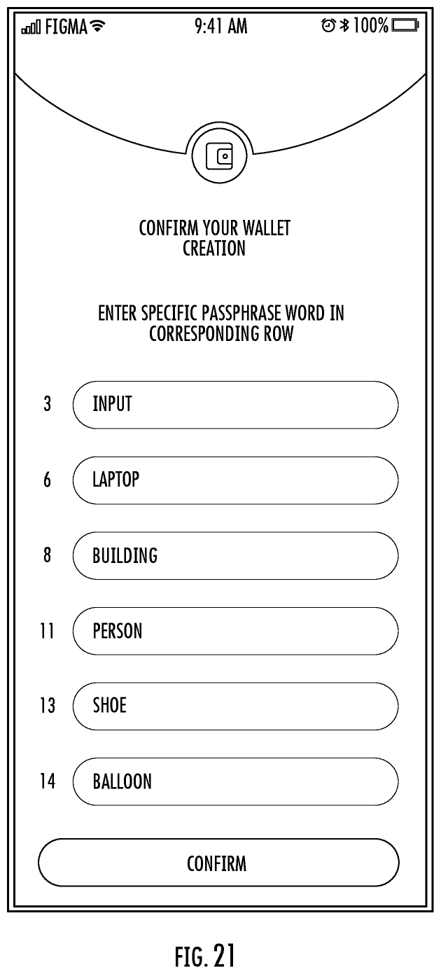

Referring now to FIGS. 18-28, various wire framed screenshots from a mobile device are illustrated to show basic operation with the operator and transaction processor 108 indicative of a company such as Keo, and an application and company such as American Express. For example, an example mobile device screen 400 is shown in FIG. 18 for setting up a pass key for the application where a pass code may be set up and entered, confirmed and after confirmation, a screenshot as in FIG. 19 showing that no wallets have yet been established, but a new wallet may be created. The create new wallet button may be selected and the application may indicate that a past phrase will be displayed and must be written down as shown in FIG. 20 with pass phrase and the 25 different words. There are no wallets yet established, but in the screen could then displayed about confirming a wallet creation by entering a specific pass phrase word in a corresponding row as shown in FIG. 21.

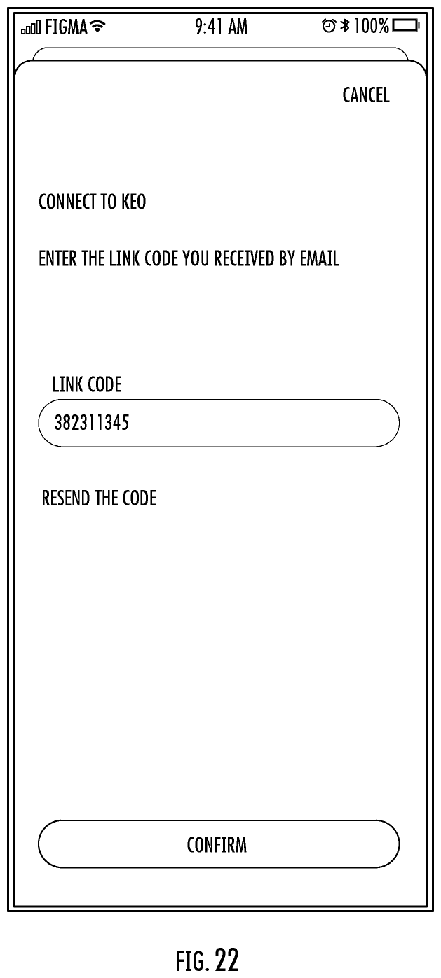

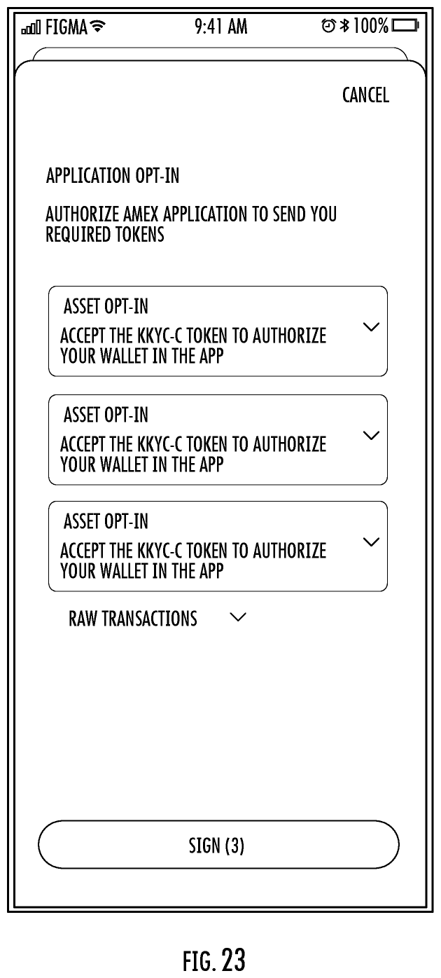

The wallet is named and the pass code entered again and the wallet name displayed with its identifier and the wallet link to the Rails processer 108 where a link may be entered as received by email as shown in FIG. 22 with the link code. The pass code may be entered again and as shown in FIG. 23, an application opt in may be accepted so that required tokens such as KKYC C tokens as shown in FIG. 23. An example are tokens in the C programming language.

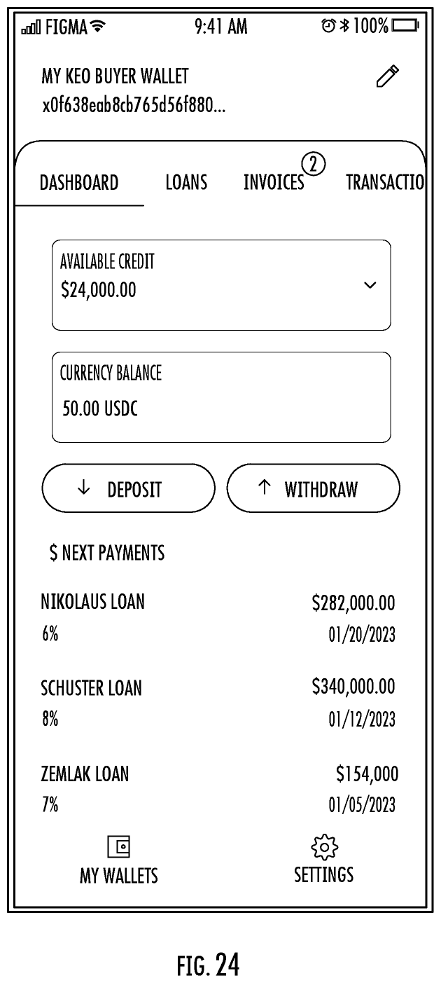

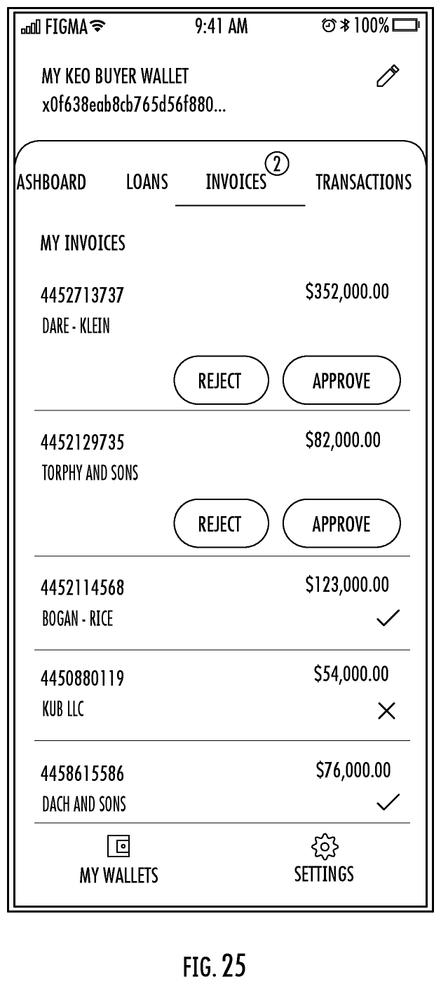

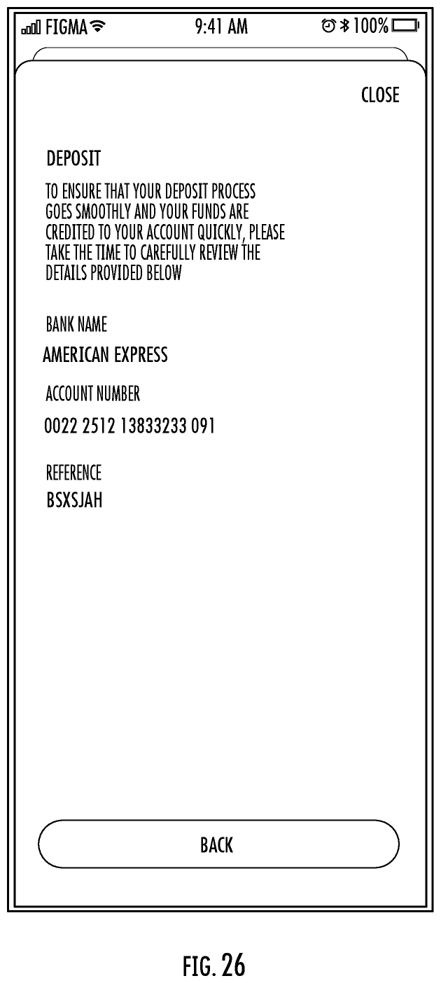

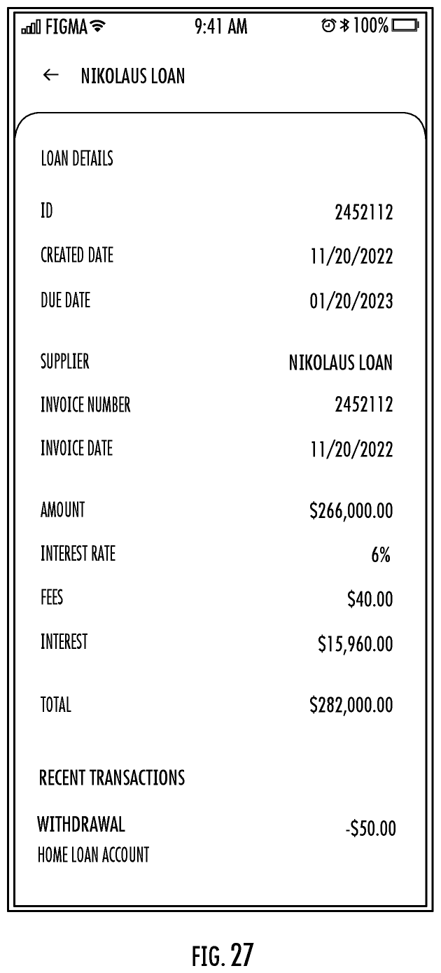

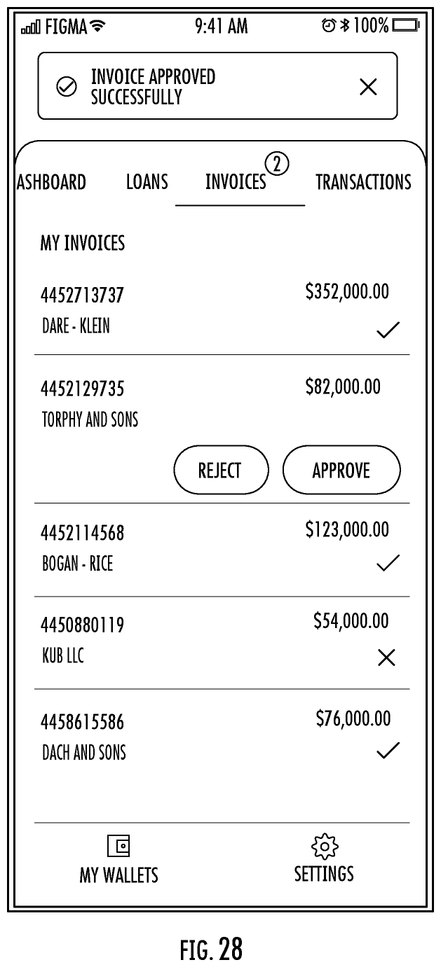

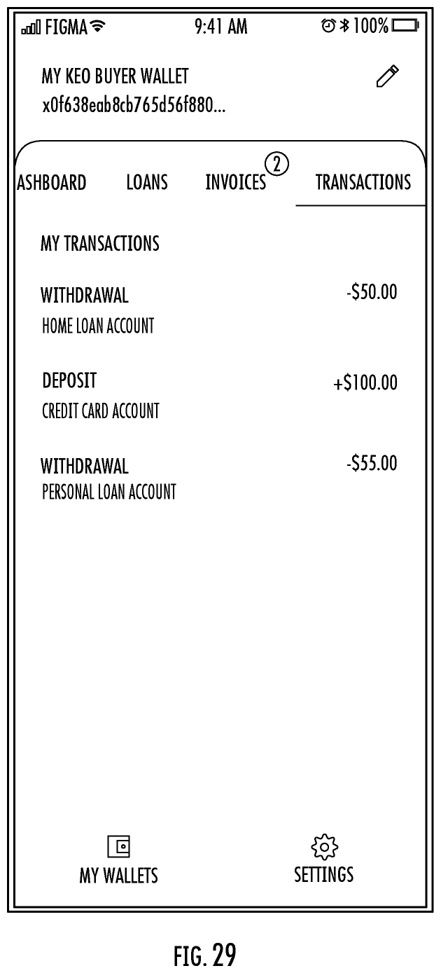

The mobile device may display the wallet as shown in FIG. 24 with the dashboard showing available credit and a currency ballot with a button that may be selected for deposit and withdrawal and showing the different loans. FIG. 25 shows how different invoices may be rejected and approved and FIG. 26 shows the deposit to a bank name with an account number. If the loan details are shown in a screenshot for FIG. 27 and loans may be paid as well as invoices that may be approved by a buyer, for example, as shown in the screenshot of FIG. 28. Invoice could also be rejected. FIG. 29 shows the different transactions that have been established such as a withdrawal, deposit and another withdrawal and the different loan accounts and credit card accounts.

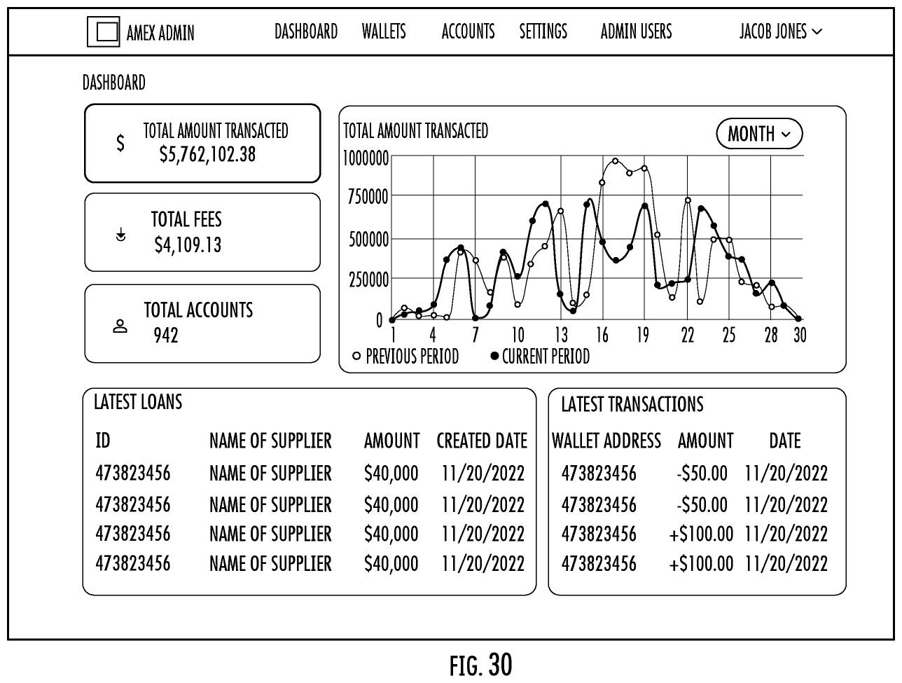

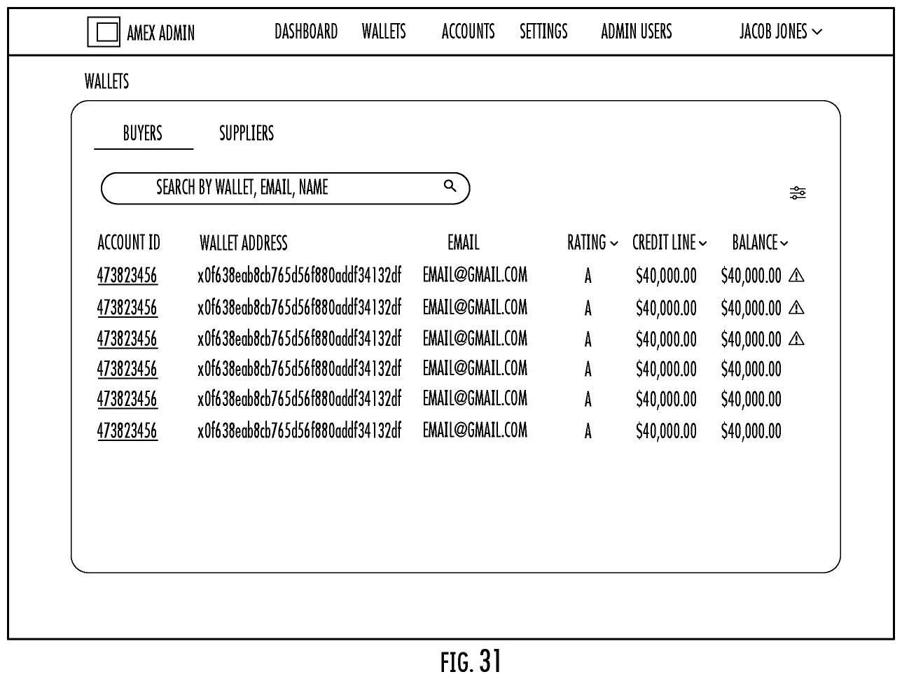

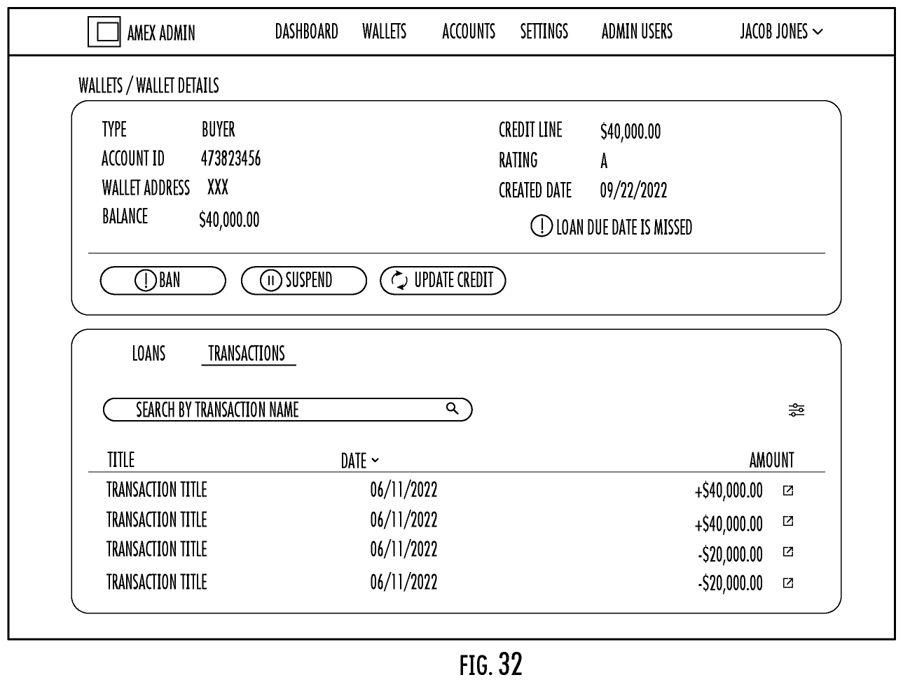

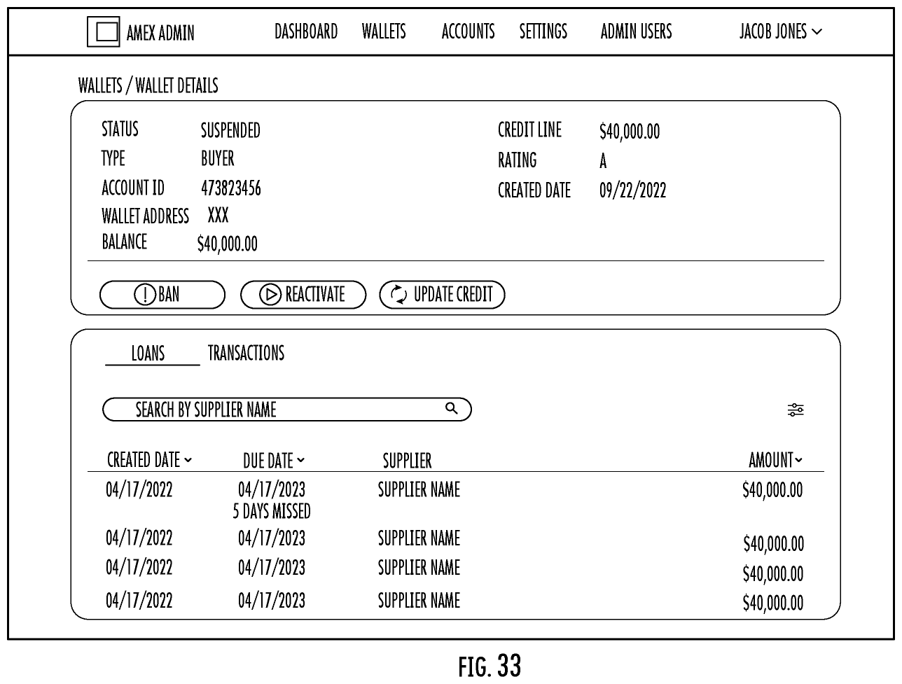

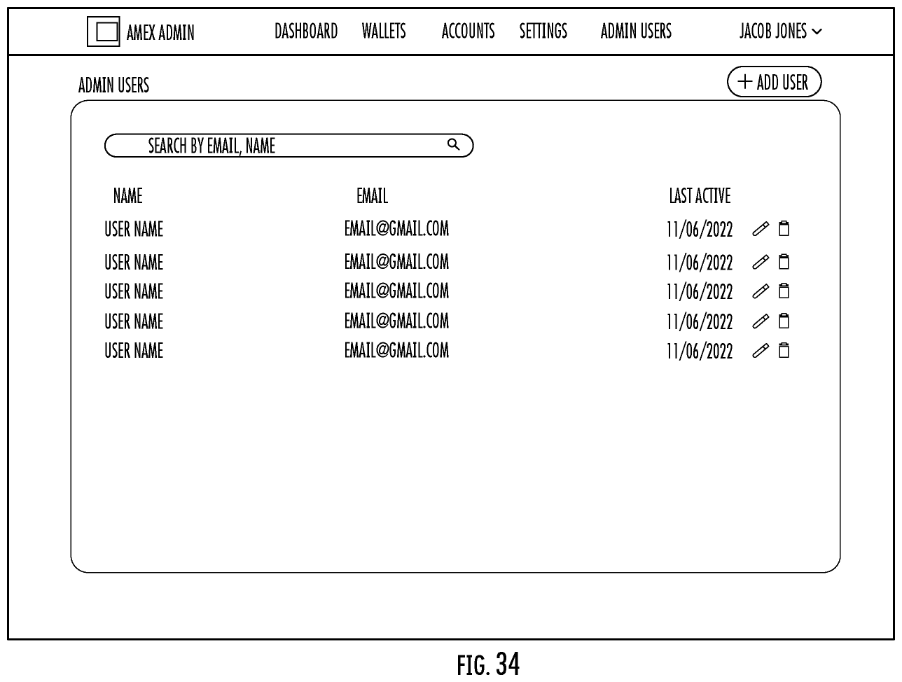

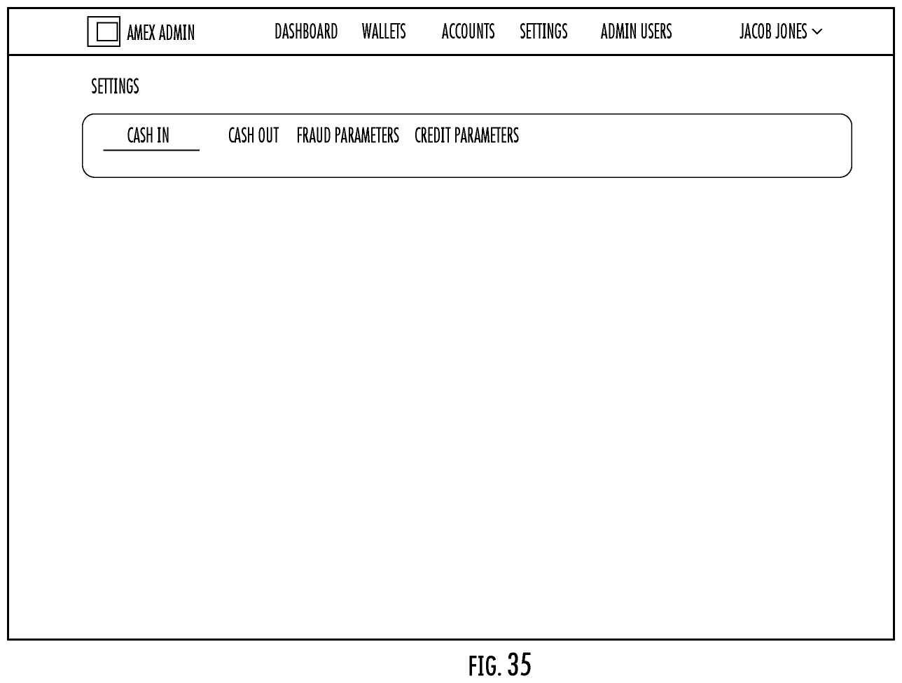

An administrator function dashboard and display is shown in FIGS. 30-34 where wallet details for different loans could be displayed and the dashboard in FIG. 30 showing the total amount that has been transacted in a graph over time with the total number of accounts and the name of various suppliers and the latest transactions. Fees generated are shown. FIG. 31 is a screenshot showing the different buyers, which would also display different suppliers. FIG. 32 shows the different wallet details for a buyer and the account ID and wallet address with the balance and indicative in this example that a loan due date has been missed. The screenshot of FIG. 33 shows how the buyer has been suspended or could have been banned and that 5 days are missed on a certain supplier name and the account could be reactivated. As shown in FIG. 34, different administrative users are shown with different settings such as cash-in and cash out fraud parameters and credit parameters in FIG. 35 as non-limiting examples of the categories.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A computing system for facilitating transactions, comprising:
a plurality of computing nodes participating in a distributed ledger on a blockchain that stores transaction blocks and smart contracts, one of said smart contracts comprising a lending pool smart contract, wherein each computing node is configured to store and maintain a respective copy of the distributed ledger;
a transaction processor connected to at least one of the computing nodes and configured to participate in the distributed ledger and transact between a buyer self-custodial wallet on a buyer computing device and a supplier self-custodial wallet on a supplier computing device, wherein said supplier self-custodial wallet is configured to generate and upload invoices to the transaction processor, said transaction processor is configured to mint the invoices as non-fungible tokens on the blockchain, and said buyer self-custodial wallet configured to pay the invoices to buy items via a loan provided by the lending pool smart contract.

2. The computing system of claim 1 wherein a lending pool smart contract holds stablecoin tokens.

3. The computing system of claim 1 wherein the buyer computing device comprises a processor, memory and transceiver.

4. The computing system of claim 1 wherein said supplier computing device comprises a processor, memory and transceiver.

5. The computing system of claim 1 wherein said transaction processor comprises a cloud computing network.

6. The computing system of claim 1 wherein said lending pool smart contract holds stablecoin tokens from lenders used to pay suppliers.

7. The computing system of claim 1 further comprising local on/off currency ramps configured to operate with the buyer and supplier self-custodial wallets, and said transaction processor is configured integrate with the local on/off currency ramps for fiat and stablecoin conversion.

8. The computing system of claim 1 wherein said transaction processor is configured to issue a QR code to a buyer computing device for display thereon, wherein said QR code contains data of a transaction card for in-person purchases at a supplier.

9. The computing system of claim 1 further comprising a cache storage for storing one or more of access and refresh tokens invalidation, link codes and mobile wallet signed transactions.

10. The computing system of claim 1 wherein said lending pool smart contract comprises a stateful smart contract having loop feedback.

11. The computing system of claim 1 wherein the transaction processor is configured to save the transaction between a buyer and supplier to the blockchain.

12. A computing system for facilitating transactions, comprising:
a plurality of computing nodes participating in a distributed ledger on a blockchain that stores transaction blocks and smart contracts, one of said smart contracts comprising a lending pool smart contract, wherein each computing node is configured to store and maintain a respective copy of the distributed ledger;
a transaction processor connected to at least one of the computing nodes and configured to participate in the distributed ledger and transact between a buyer self-custodial wallet on a buyer computing device and a supplier self-custodial wallet on a supplier computing device, wherein said supplier self-custodial wallet is configured to generate and upload invoices to the transaction processor, said transaction processor is configured to mint the invoices as non-fungible tokens on the blockchain, and said buyer self-custodial wallet configured to pay the invoices to buy items via a loan provided by the lending pool smart contract, said transaction process further comprising a module and application to operate invoices and loans on the blockchain, manage invoices off the blockchain, and onboard and connect buyers and suppliers.

13. The computing system of claim 12 wherein a lending pool smart contract holds stablecoin tokens.

14. The computing system of claim 12 wherein said lending pool smart contract holds stablecoin tokens from lenders used to pay suppliers.

15. The computing system of claim 12 further comprising local on/off currency ramps configured to operate with the buyer and supplier self-custodial wallets, and said transaction processor is configured integrate with the local on/off currency ramps for fiat and stablecoin conversion.

16. The computing system of claim 12 wherein said transaction processor is configured to issue a QR code to a buyer computing device for display thereon, wherein said QR code contains data of a transaction card for in-person purchases at a supplier.

17. The computing system of claim 12 further comprising a cache storage for storing one or more of access and refresh tokens invalidation, link codes and mobile wallet signed transactions.

18. The computing system of claim 12 wherein said lending pool smart contract comprises a stateful smart contract having loop feedback.

19. The computing system of claim 12 wherein the transaction processor is configured to save the transaction between a buyer and supplier to the blockchain.
